(19) United States
(12) Patent Application Publication
(10) Pub. No.: US 2026/0194896 A1
(43) Pub. Date: Jul. 9, 2026

(54) METHODS AND MECHANISMS TO PERFORM MAINTENANCE EVENT DIAGNOSTICS USING DATA MATCHING TECHNIQUES

(71) Applicant: Applied Materials, Inc., Santa Clara, CA (US)

(72) Inventors: Jimmy Iskandar, Fremont, CA (US); Suketu Parikh, San Jose, CA (US); Tsz Keung Cheung, San Jose, CA (US); Minal Balkrishna Shettigar, San Jose, CA (US); Isabel Li, Milpitas, CA (US); Michael D. Armacost, San Jose, CA (US)

(21) Appl. No.: 19/014,967

(22) Filed: Jan. 9, 2025

(51) Int. Cl. G05B 23/02

(52) U.S. Cl. CPC G05B 23/0275; G05B 23/0283

(57) ABSTRACT

A system configured to, in response to an occurrence of a corrective maintenance event, obtain first sensor data pertaining to a first process run and second sensor data pertaining to a second process run. Responsive to determining that a comparison of the first sensor data and the second sensor data fails to satisfy a first threshold criterion, the system generates a first normalized dataset based on the first sensor data and a second normalized dataset based on the second sensor data. The system then generates trace matching data by performing a trace matching operation on the first normalized dataset and the second normalized dataset. Responsive to determining that the trace matching data satisfies a second threshold criterion, the system identifies a set of sensors associated with the first sensor data as the cause of the fault that triggered the corrective maintenance event.

### TECHNICAL FIELD

The present disclosure relates to methods and mechanisms for performing maintenance event diagnostics using data matching techniques.

### BACKGROUND

Manufacturing of modern materials often involves various deposition techniques, such as chemical vapor deposition (CVD) or physical vapor deposition (PVD) techniques, in which atoms or molecules of one or more selected types are deposited on a semiconductor device (e.g., a substrate) held in low or high vacuum environments that are provided by vacuum processing (e.g., deposition, etching, etc.) chambers. Materials manufactured in this manner can include monocrystals, semiconductor films, fine coatings, and numerous other substances used in practical applications, such as electronic device manufacturing. Many of these applications depend on the purity and specifications of the materials grown in the processing chambers. The quality of such materials, in turn, depend on adherence of the manufacturing operations to correct process specifications. To maintain isolation of the inter-chamber environment and to minimize exposure of substrates to ambient atmosphere and contaminants, various sensor detection techniques are used to monitor processing chamber environment, substrate transportation, physical and chemical properties of the products, and the like to detect potential anomalies and issues. Improving precision, reliability, and efficiency of such monitoring presents a number of technological challenges that impede progress of electronic device manufacturing and negatively impact the quality of the products of semiconductor device manufacturing.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a system is configured to, in response to an occurrence of a corrective maintenance event, obtain first sensor data pertaining to a first process run and second sensor data pertaining to a second process run. The first process run is associated with an occurrence of a fault that triggered the corrective maintenance event. Responsive to determining that a comparison of the first sensor data and the second sensor data fails to satisfy a first threshold criterion, the system generates a first normalized dataset based on the first sensor data and a second normalized dataset based on the second sensor data. The system then generates trace matching data by performing a trace matching operation on the first normalized dataset and the second normalized dataset. Responsive to determining that the trace matching data satisfies a second threshold criterion, the system identifies a set of sensors associated with the first sensor data as the cause of the fault that triggered the corrective maintenance event.

A further aspect of the disclosure includes a method according to any aspect or implementation described herein.

A further aspect of the disclosure includes a non-transitory computer-readable storage medium comprising instructions that, when executed by a processing device operatively coupled to a memory, performs operations according to any aspect or implementation described herein.

### BRIEF DESCRIPTION OF THE DRAWINGS

The present disclosure is illustrated by way of example, and not by way of limitation in the figures of the accompanying drawings.

FIG. 1 is a block diagram illustrating an example system architecture, in accordance with some implementations of the present disclosure.

FIG. 2 is a top schematic view of an example manufacturing system, in accordance with some implementations of the present disclosure.

FIG. 3 is a block diagram illustrating an example predictive architecture, in accordance with some implementations of the present disclosure.

FIGS. 4A-D are flow diagrams of methods associated with generating a guardband, in accordance with some implementations of the present disclosure.

FIG. 5 illustrates an example guardband violation profiling, in accordance with some implementations of the present disclosure.

FIG. 6 is a diagram of the framework for performing maintenance event diagnostics and predictive maintenance, according to some aspects of the present disclosure.

FIG. 7. is a flow chart of a method for performing the set of diagnostic operations to determine the root cause of a corrective maintenance operation, according to aspects of the present disclosure.

FIG. 8 is a diagram illustrating normalizing guardband data, according to aspects of the present disclosure.

FIG. 9 is a diagram illustrating a listing of tests, according to aspects of the present disclosure.

FIG. 10 depicts a flow diagram of an example method for training predictive maintenance model to generate predictive data reflecting a possible upcoming corrective maintenance event, in accordance with implementations of the present disclosure.

FIGS. 11A-11C are graphs illustrating example data used to train the predictive maintenance model, according to aspects of the present disclosure.

FIG. 12 is a flow chart of a method 1200 for generating predictive data indicative of whether a corrective maintenance event may occur, according to aspects of the present disclosure.

FIG. 13 is a block diagram illustrating a computer system, according to certain implementations.

### DETAILED DESCRIPTION

Described herein are technologies directed to methods and mechanisms for performing maintenance event diagnostics using data matching techniques. In particular, the implementations can monitor different components and sub-systems across multiple process chambers and accurately perform anomaly detection and predictive maintenance operations in a manufacturing process and/or a product of the process to prevent a deterioration of the product yield. A sub-system can refer to a pressure sub-system, a flow sub-system, a temperature sub-system and so forth, each sub-system having one or more components. A component can include, for example, a pressure pump, a vacuum, a gas deliver line, etc. Further, the implementations disclosed can help accurately identify and/or classify the detected anomalies using statistics data and trace data (sensor data received over a period of time corresponding to at least part of a recipe or process run) from different maintenance events (e.g., preventive maintenance, corrective maintenance, etc.).

Preventive maintenance refers to performing scheduled maintenance activities to help prevent unexpected issues or failures during future operation of a manufacturing system. Preventive maintenance can be performed at fixed intervals, such as, for example, after a certain operating time has passed, after a certain throughput has been produced, etc. Corrective maintenance (also known as “reactive maintenance”) refers to repairing or replacing one or more components of a manufacturing system in response to an unexpected failure (e.g., a breakdown, a jam, a malfunction, etc.). Corrective maintenance may involve identifying the issue, correcting the issue, and restoring operation of the manufacturing equipment (referred to as “tool-up”).

The robotic delivery and retrieval of substrates, as well as maintaining controlled environments in loading, processing, and transfer chambers improve speed, efficiency, and quality of the semiconductor device manufacturing. Typical semiconductor device manufacturing processes often require tens or hundreds of steps, e.g., introducing a gas into a processing chamber, heating the chamber environment, changing a composition of gas, purging a chamber, pumping the gas out, changing pressure, moving a substrate from one position to another, creating or adjusting a plasma environment, performing etching or deposition steps, and so on. The very complexity of the semiconductor manufacturing technology requires processing a constant stream of run-time data from various sensors placed inside the manufacturing system. Such sensor can include temperature sensors, pressure sensors, chemical sensors, gas flow sensors, motion sensors, position sensor, optical sensors, and other types of sensors. The manufacturing system can have multiple sensors of the same (or similar) type distributed throughout various parts of the system. For example, a single processing chamber can have multiple chemical sensors to detect concentration of chemical vapor at various locations within the processing chamber and can similarly have multiple temperature sensors to monitor a temperature distribution. Some or all of the sensors can output a constant stream of data. For example, a temperature sensor can output a temperature reading ever second (or more frequently) so that a single etching step that takes several minutes to perform can be generate hundreds of data points (referred to as trace data) from this sensor alone.

Each sensor (alone or in combination with other sensors) can output data that is indicative of a sudden or gradual detrimental changes in the environment or in the settings of the manufacturing process. In addition, similar sensors in different process chambers can exhibit distinct behavior (e.g., deterioration rate, output variations, etc.), especially after each respective process chamber is subjected to a maintenance routine during a maintenance event. In some systems, performing diagnostics (e.g., identifying issues) during a maintenance event is typically done in an ad-hoc manner using simple techniques and limited scope (e.g., ignoring data from other maintenance events). As such, current diagnostics procedures simply indicate which sensor may be at fault but fail to identify the type of issue that occurred and the potential root causes of the issue. Further, current systems fail to perform predictive maintenance capable of predicting possible future maintenance related issues based on data anomalies identified during current process runs.

Aspects and implementations of the present disclosure address these and other shortcomings of the existing technology by performing maintenance event diagnostics using data matching techniques. In particular, during a maintenance event, the system of the present disclosure can compare sensor data (e.g., trace data) from multiple manufacturing related faucets which can refer to one or more process runs (or portions of a process run), one or more maintenance events, and/or reference data. For example, sensor data can be obtained from data related to the processing of one or more substrates immediately prior to or after a preventive maintenance event, immediately prior to or after a corrective maintenance event, at certain times during a process run, from reference trace data (data known to have been generated from a batch of substrates produced within desired specifications), or any combination thereof. A process run can refer to the execution of a process recipe in a process chamber. Multiple process runs can be completed between the between a tool-up event (e.g., after maintenance is completed) and a new maintenance event (e.g., a corrective maintenance event, a preventive maintenance event). In an illustrative example, the system of the present disclosure can compare trace data between one or more process runs right prior to a corrective maintenance event and one or more process runs in the middle of the maintenance event, between one or more process runs right prior to a corrective maintenance event and one or more process runs right prior to a previous maintenance event, between one or more process runs right after a tool-up event and one or more process runs right after a previous tool-up event, and so forth. This allows for comprehensive monitoring of the process runs.

The comparisons can be performed using summary statistics, trace matching related to the sensor data, etc. Summary statistics can refer to sensor data summarized across a process run or a portion of a process run using a set of statistics such as mean and variance. Trace matching can refer to trace data summarized across a process run or portion of a process run using a set of statistics. Using the comparison data from multiple manufacturing related faucets, the system of the present disclosure can more accurately perform anomaly detection operations.

In some implementations, the system of the present disclosure can implement a predictive maintenance (machine-learning) model to predict possible corrective maintenance events. In particular, the predictive maintenance model can be trained using summary statistics and/or trace matching data. The trained predictive maintenance model can then process current sensor and/or trace data associated with one or more substrate fabrication (or manufacturing) processes to generate predictive data reflecting whether the manufacturing system is expected to experience a corrective maintenance event (e.g., be shut down due to a component failure). For example, the predictive data can indicate that a certain sensor spike or drift will occur which can lead to a corrective maintenance event. Using the predictive data, the system of the present disclosure can determine the type of issue or root cause of the anomaly that can cause the predicted corrective maintenance event by, for example, performing a lookup of the predicted anomalous data in a database. The database can correlate anomalous data (e.g., trace shapes, sensor spikes, drift data, etc.) to their corresponding identification data (data used to identify the type or behavior of the anomaly) and/or root causes. In some implementations, the system can perform a corrective action based on the identified anomalous data. A corrective action can include one or more operations performed to adjust an operating condition (e.g., a parameter of a process recipe) of a process chamber during a process run. For example, a corrective action can include increasing heater current, decrease gas flowrate, etc. Accordingly, the system can perform a lookup of a corresponding corrective action for the identified anomalous data.

Aspects of the present disclosure result in technological advantages of improving the accuracy of anomaly detection techniques during a manufacturing process. Aspects of the present disclosure further enable the detection of anomaly data that can lead to a corrective maintenance event. This allows the users of the manufacturing system to correct the related issue, thus saving considerable costs and preventing unscheduled and lengthy downtime related to performing repairs during corrective maintenance events. Additionally, aspects of the present disclosure provide significant reduction in time and data required to process the sensor data to detect the possible anomalies.

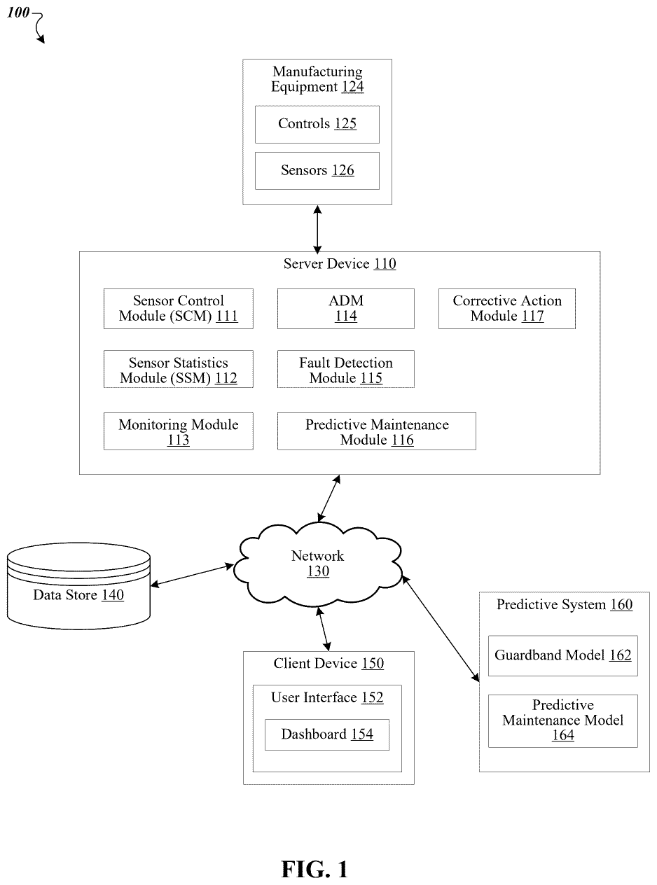

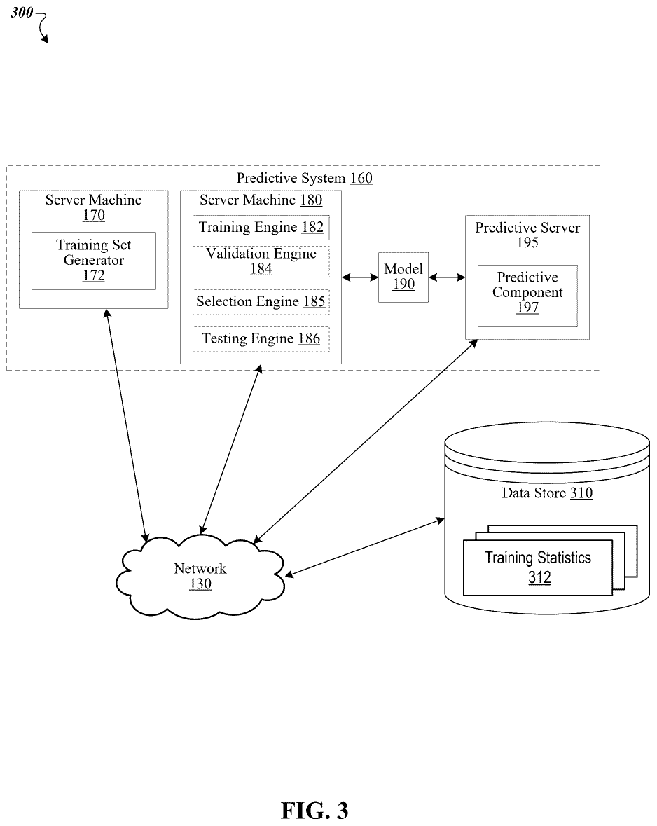

FIG. 1 depicts an illustrative computer system architecture 100, according to aspects of the present disclosure. In some implementations, computer system architecture 100 can be included as part of a manufacturing system for processing substrates. Computer system architecture 100 includes a server device 110, manufacturing equipment 124, predictive system 160 (e.g., to generate predictive data, to provide model adaptation, to use a knowledge base, etc., which will be described in detail in FIG. 3), data store 140, and client device 150. The manufacturing equipment 124 can include sensors 126 configured to capture data for a substrate being processed at the manufacturing system. In some implementations, the manufacturing equipment 124 and sensors 126 can be part of a sensor system that includes a sensor server (e.g., field service server (FSS) at a manufacturing facility) and sensor identifier reader (e.g., front opening unified pod (FOUP) radio frequency identification (RFID) reader for sensor system). In some implementations, metrology equipment can be part of computer system architecture 100 that includes a metrology server (e.g., a metrology database, metrology folders, etc.) and metrology identifier reader (e.g., FOUP RFID reader for metrology system).

Manufacturing equipment 124 can produce products, such as electronic devices, following a recipe or performing runs over a period of time. Manufacturing equipment 124 can include a process chamber. Manufacturing equipment 124 can perform a process for a substrate (e.g., a wafer, etc.) at the process chamber. Examples of substrate processes include a deposition process to deposit one or more layers of film on a surface of the substrate, an etch process to form a pattern on the surface of the substrate, etc. Manufacturing equipment 124 can perform each process according to a process recipe. A process recipe defines a particular set of operations to be performed for the substrate during the process and can include one or more settings associated with each operation. For example, a deposition process recipe can include a temperature setting for the process chamber, a pressure setting for the process chamber, a flow rate setting for a precursor for a material included in the film deposited on the substrate surface, etc.

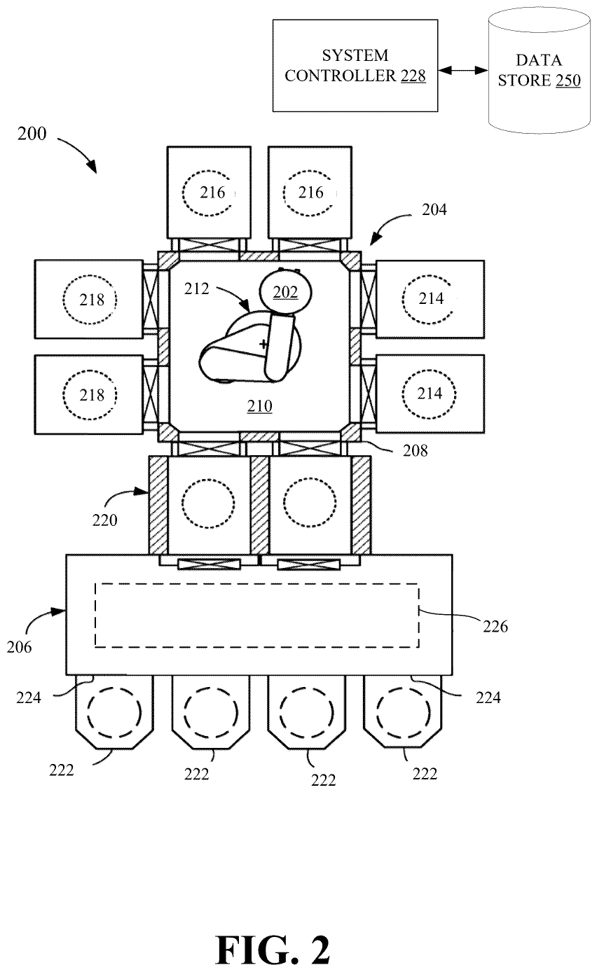

In some implementations, manufacturing equipment 124 includes sensors 126 that are configured to generate data associated with a substrate processed at manufacturing system 100. For example, a process chamber can include one or more sensors configured to generate spectral or non-spectral data associated with the substrate before, during, and/or after a process (e.g., a deposition process, an etch process, etc.) is performed for the substrate. In some implementations, spectral data generated by sensors 126 can indicate a concentration of one or more materials deposited on a surface of a substrate. Sensors 126 configured to generate spectral data associated with a substrate can include reflectometry sensors, ellipsometry sensors, thermal spectra sensors, capacitive sensors, and so forth. Sensors 126 configured to generate non-spectral data associated with a substrate can include temperature sensors, pressure sensors, flow rate sensors, voltage sensors, etc. For example, each sensor 126 can be a temperature sensor, a pressure sensor, a chemical detection sensor, a chemical composition sensor, a gas flow sensor, a motion sensor, a position sensor, an optical sensor, or any and other type of sensors. Some or all of the sensors 126 can include a light source to produce light (or any other electromagnetic radiation), direct it towards a target, such as a component of the machine 100 or a substrate, a film deposited on the substrate, etc., and detect light reflected from the target. The sensors 126 can be located anywhere inside the manufacturing equipment 124 (for example, within any of the chambers including the loading stations, on one or more robots, on a robot blade, between the chambers, and so one), or even outside the manufacturing equipment 124 (where the sensors can test ambient temperature, pressure, gas concentration, and so on). Further details regarding manufacturing equipment 124 are provided with respect to FIG. 2.

In some implementations, sensors 126 provide sensor data (e.g., sensor values, features, trace data) associated with manufacturing equipment 124 (e.g., associated with producing, by manufacturing equipment 124, corresponding products, such as substrates). The manufacturing equipment 124 can produce products following a recipe or by performing runs over a period of time. Sensor data received over a period of time (e.g., corresponding to at least part of a recipe or run) can be referred to as trace data (e.g., historical trace data, current trace data, etc.) received from different sensors 126 over time. Sensor data can include a value of one or more of temperature (e.g., heater temperature), spacing (SP), pressure, high frequency radio frequency (HFRF), voltage of electrostatic chuck (ESC), electrical current, material flow, power, voltage, etc. Sensor data can be associated with or indicative of manufacturing parameters such as hardware parameters, such as settings or components (e.g., size, type, etc.) of the manufacturing equipment 124, or process parameters of the manufacturing equipment 124. The sensor data can be provided while the manufacturing equipment 124 is performing manufacturing processes (e.g., equipment readings when processing products). The sensor data can be different for each substrate.

In some implementations, manufacturing equipment 124 can include controls 125. Controls 125 can include one or more components or sub-systems configured to enable and/or control one or more processes of manufacturing equipment 124. For example, a sub-system can include a pressure sub-system, a flow sub-system, a temperature sub-system and so forth, each sub-system having one or more components. The component can include, for example, a pressure pump, a vacuum, a gas deliver line, a plasma etcher, actuators etc. In some implementations, controls 125 can be managed based on data from sensors 126.

In some implementations, certain sensors 126 and controls 125 can be related to one or more control modules. In particular, each control module can include a set of sensors 126, controls 125, control logic regulating the sensors and/or components, etc. In an illustrative example, the controls modules can include a thermal control module, a plasma control module, a reactant flux control module, and a substrate control module. The thermal control module can include sensors and controls related to providing and maintain a heating environment in a process chamber (e.g., heater, heater sensor, etc.). The plasma control module can include sensors and controls related to creating or adjusting a plasma environment in a process chamber (e.g., plasma etcher, etcher sensor, etc.). The reactant flux control module can include sensors and controls related to the gas flow operations in a process chamber (e.g., gas flow control and sensor, pump, etc.). The substrate control module can include sensors and controls related to substrate properties (e.g., warp experience by a substrate). In certain implementations, sensor data from one or more of the particular control modules can be processed and analyzed, via modules 111-117 and the methods discussed herein, to control the respective operating conditions (e.g., a parameter of a process recipe) associated with said process control module.

The client device 150 can include a computing device such as personal computers (PCs), laptops, mobile phones, smart phones, tablet computers, netbook computers, network connected televisions (“smart TVs”), network-connected media players (e.g., Blu-ray player), a set-top box, over-the-top (OTT) streaming devices, operator boxes, etc. Client device 150 can display a graphical user interface (GUI) 152. In some implementations, client device 150 can provide, for display on GUI 152, sensor data, predictive data (e.g., data from predictive system 160), server data (e.g., any data generated and/or provided by server device 110), or any other data items. In some implementations, GUI 152 can enable the user to provide, as input, data, commands, etc. Each client device 150 can include an operating system that allows users to generate, view, or edit data (e.g., indication associated with manufacturing equipment 124, corrective actions associated with manufacturing equipment 124, etc.).

Server device 110 can include one or more computing devices (e.g., a server machine, computer, etc.) configured to perform one or more diagnostic related operations. A diagnostic related operation can refer to any operation performed by modules 111-117, such as, for example, data processing, data acquisition, data analysis, troubleshooting, trace matching, event matching, fault identification, anomaly detection, alert generation, selecting and/or performing a corrective action, and so forth. The server device 110 can include sensor control module (SCM) 111, sensor statistic module (SSM) 112, monitoring module 113, anomaly detection module (ADM) 114, fault detection module 115, predictive maintenance module 116, and corrective action module 117.

The SCM 111 can activate sensors, deactivate sensors, place sensors in an idle state, change settings of the sensors, detect sensor hardware or software problems, and so on. In some implementations, the SCM 111 can keep track of the processing operations performed by the manufacturing equipment 124 and determine which sensors 126 to be sampled for a particular processing (or diagnostic, maintenance, etc.) operation of the manufacturing equipment 124. For example, during a chemical deposition step inside one of the processing chambers, the SCM 111 can sample sensors 126 that are located inside the respective processing chamber but not activate (or sample) sensors 126 located inside the transfer chamber and/or the loading station. The raw data obtained by the SCM 111 can include time series data where a specific sensor 126 captures or generates one or more readings of a detected quantity at a series of times. For example, a pressure sensor can generate N pressure readings P(tᵢ) at time instances t₁, t₂, . . . t_{N}. In some implementations, the raw data obtained by the SCM 111 can include spatial maps at a pre-determined set of spatial locations. For example, an optical reflectivity sensor can determine reflectivity of a film deposited on the surface of a wafer, R(xⱼ, yₗ), at a set (e.g., a two-dimensional set) of spatial locations xⱼ, yₖ, on the surface of the film/wafer. In some implementations, both the time series and the spatial maps raw data can be collected. For example, as the film is being deposited on the wafer, the SCM 111 can collect the reflectivity data from various locations on the surface of the film and at a set of consecutive instances of time, R(tᵢ, xⱼ, yₗ).

SSM 112 can process the raw data obtained by the SCM 111 from the sensors 126 and determine statistics representative of the raw data (referred to as “statistics data”). For example, for each or some of the raw sensor data distributions, the SSM 112 can determine one or more parameters of the distribution, such as a mean, a median, a mode, an upper bound, a lower bound, a variance (or a standard deviation), a skewness (third moment), a kurtosis (fourth moment), or any further moments or cumulants of the data distribution. In some implementations, the SSM 112 can model (e.g., via regression analysis fitting) the raw data with various model distributions (normal distribution, log-normal distribution, binomial distribution, Poisson distribution, Gamma distribution, or any other distribution. In such implementations, the one or more parameters can include an identification of the fitting distribution being used together with the fitting parameters determined by the SSM 112. In some implementations, the SSM 112 can use multiple distributions to fit the raw data from one sensor, e.g., a main distribution and a tail distribution for outlier data points. The parameters of the distributions obtained by the SSM 112 can be sensor-specific. For example, for some sensors a small number of parameters can be determined (mean, median, variance) whereas for some sensor many more (e.g., 10 or 20) moments can be determined.

Monitoring module 113 can generate one or more graphical user interfaces (GUI) (e.g., GUI 152) to monitor the one or more sensors and/or sensor groups. In some implementations, monitoring module 113 can generate a dashboard 154 configured to track the output data generated by the sensors of one or more sensor groups. The health index GUI can display each sensor of one or more sensor groups (or a subset of sensors from one or more sensor groups) and their respective output values over a timeline (e.g., a time, a number of process runs, etc.). In some implementations, for one or more of the displayed sensors, one or more limits can be displayed. The limits (e.g., fault detection limits) can be indicative of a deviation, a fault, an anomaly, or any other indication of abnormal or irregular data.

Sensors can be sorted or categorized into one or more groups by, for example, monitoring module 113. In some implementations, monitoring module 113 can use the sensor data obtained from SCM 111, SSM 112, or any other module or data store that include raw or proceed sensor data. Each group can be defined by certain properties or characteristics of the sensors or the data generated by the sensors. For example, the groups can be defined based on sensor settings, sensor output data types, sensor quality, the sub-system the sensor is correlated to (e.g., flow sub-system, temperature sub-system, pressure sub-system, etc.), etc. The sensors can be grouped from one of more process chambers of manufacturing equipment 124, or from process chambers of multiple manufacturing tools (e.g., manufacturing equipment or components thereof). In some implementations, monitoring module 113 can use one or more algorithms to categorize sensors into one or more specific groups. In some implementations, monitoring module 113 can use a detection algorithm to categorize sensors into one or more specific groups. The detection algorithm(s) can be configured to correlate each sensor to one or more predefined groups based on one or more predefined criterion.

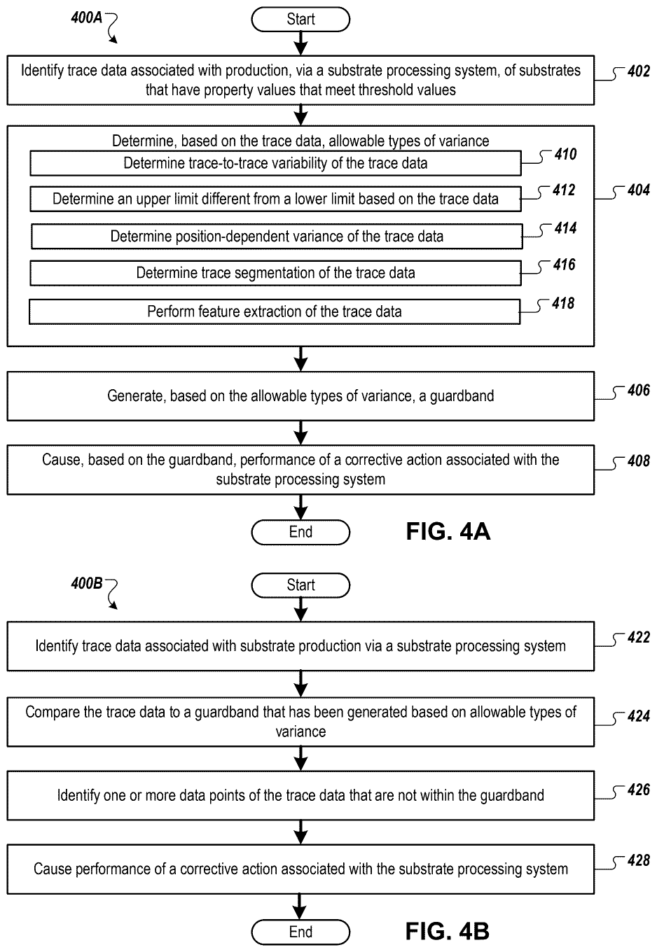

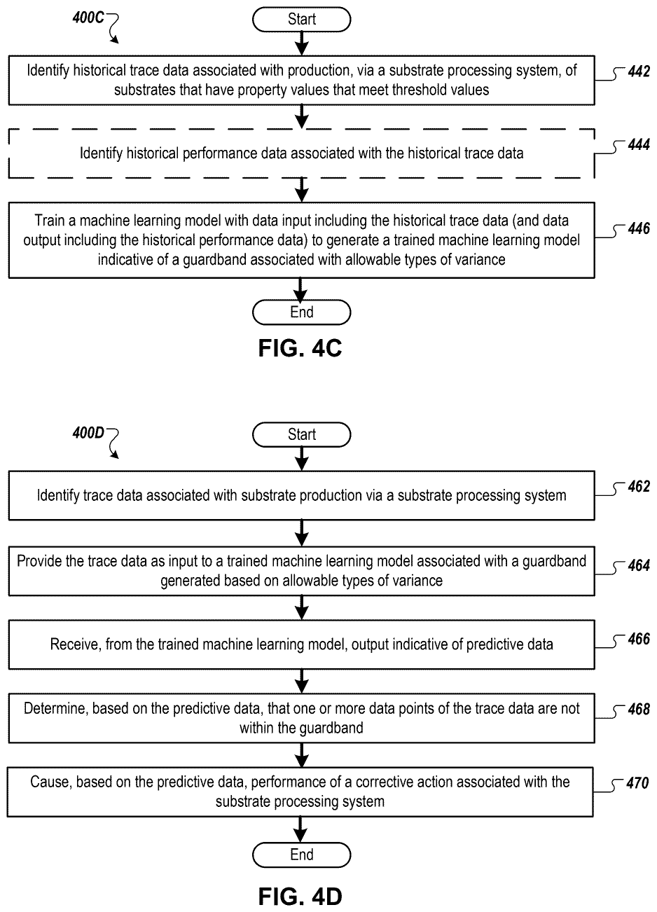

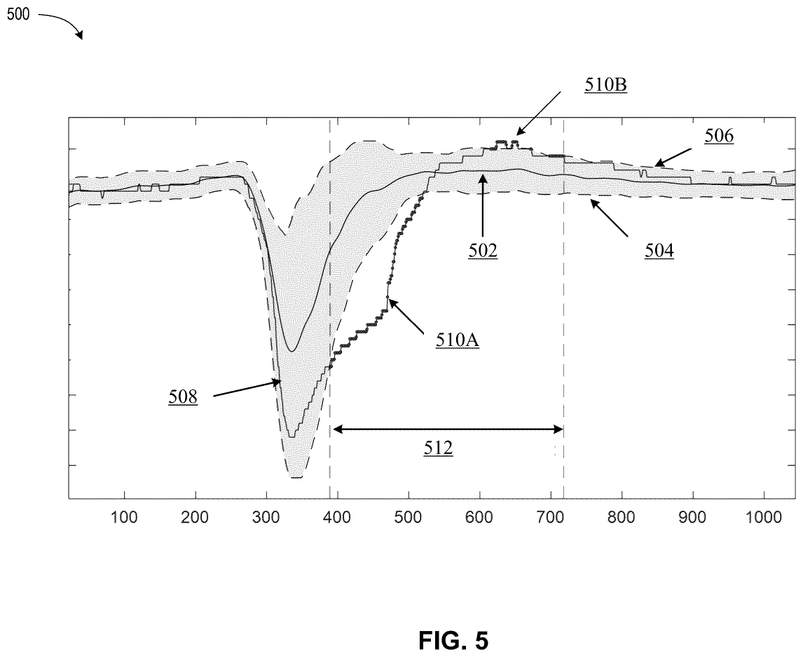

ADM 114 can perform diagnostic operations using the sensor data. In particular, ADM 114 can pre-process, reduce the dimensionality of the sensor statistics, process the reduced representations of statistics by multiple anomaly detection models, normalize, and/or process using a detector neural network to determine one or more anomaly scores. At least some of the listed operations can include machine-learning. In some implementations, ADM 114 can one or more detection techniques, such as, for example, statistical anomaly detection techniques (e.g., Z-score, Tukey's range test, Grubb's test, etc.), ensemble techniques (e.g., the Anomaly Detection Ensemble (ADE) system, feature bagging techniques, score normalization techniques, etc.), fuzzy logic-based outlier detection techniques, Bayesian networks, hidden Markov models (HMMs), a Fourier transform method, a trace analysis method that generates adaptive “guardbands” on certain sensors (referred to as a “Guardband system”), an anomaly detection neural network (ADN), or any other type of anomaly detection techniques. One or more machine-learning models configured to perform operations related to one or more detection techniques of ADM 114 can be generated by the predictive system 160. In some implementations, predictive system 160 can generate different trained machine-learning models, each configured to perform multiple different types of detection techniques. An illustrative example for implementing a Guardband system and performing trace matching using the Guardband system is discussed with regards to FIGS. 4A-5.

In some implementations, ADM 114 can process data obtained from modules 111-113 by performing one or more event matching operations to generate event matching data for one or more process chambers. An event matching operation can include, for example, comparing sensor and/or trace data (e.g., data over time) from one or more process runs (or portions of a process run), one or more maintenance events, and/or from reference data. An event can refer to the performance of a maintenance related operation, such as, for example, a preventive maintenance event, a corrective maintenance event, a tool-up event, etc. Preventive maintenance refers to performing scheduled maintenance activities to help prevent unexpected issues or failures during future operation of manufacturing equipment 124. Preventive maintenance can be performed at fixed intervals, such as, for example, after a certain operating time has passed, after a certain throughput has been produced, etc. Corrective maintenance (also known as “reactive maintenance”) refers to repairing or replacing one or more components of manufacturing equipment 124 in response to an unexpected failure (e.g., a breakdown, a jam, a malfunction, etc.). Corrective maintenance may involve identifying the issue (or fault), correcting the issue, and restoring operation of manufacturing equipment 124. A tool-up event refers when manufacturing equipment 124 is ready for operation or has been initiated to perform operation after maintenance (preventive or corrective) is completed.

The event matching operations can include, for example, quality recipe trace matching, fingerprint recipe trace matching, diagnostic matching, pre-corrective maintenance matching, post maintenance matching, pre-post maintenance matching. These event matching operation are discussed in detail with regards to FIG. 6.

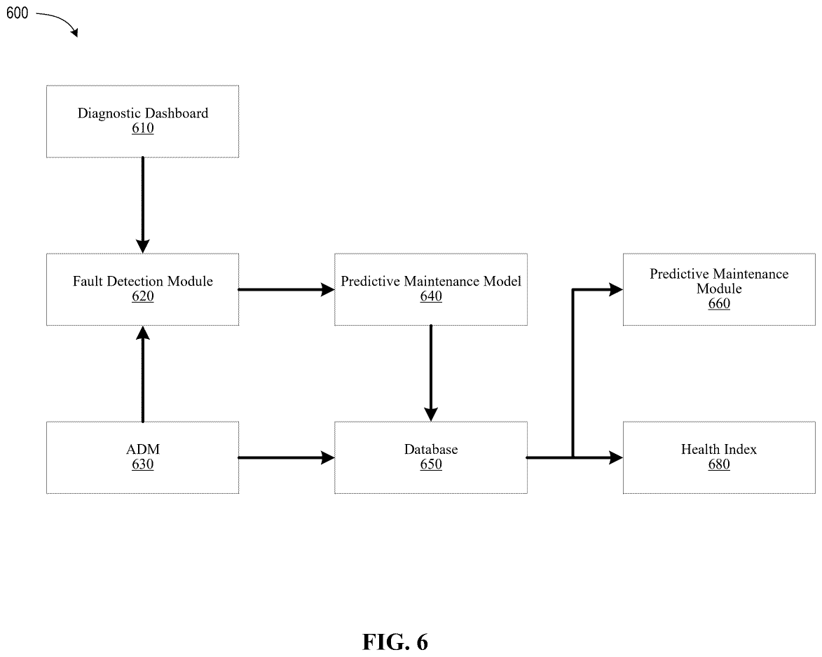

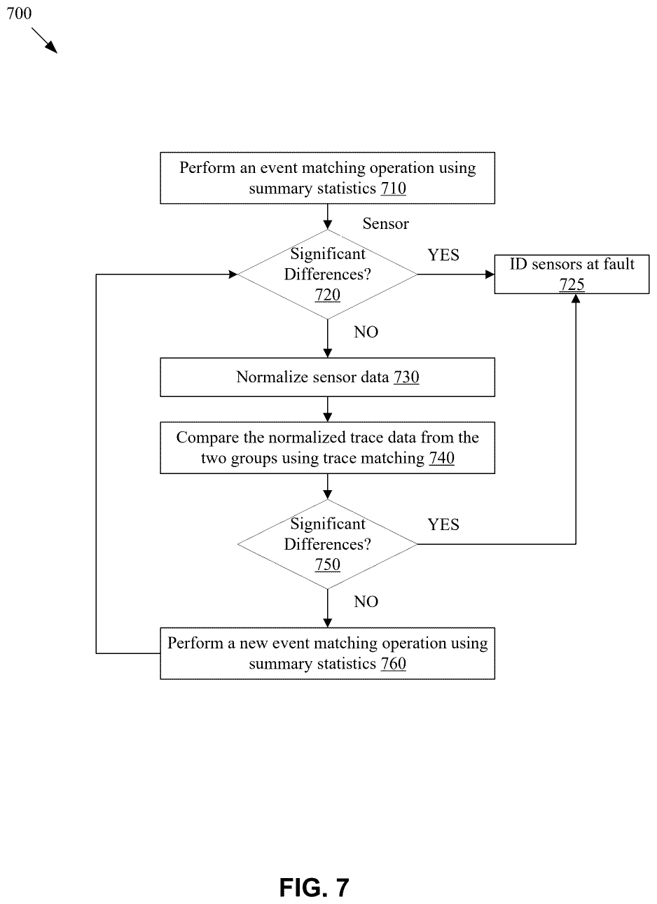

Fault detection module 115 can process, aggregate, and analyze the sensor data collected by SCM module 111, the statistics collected by the SSM 112, and/or the anomaly data (e.g., event matching data) generated by ADM 114. In particular, fault detection module 115 performs a set of operations to determine the root cause of a fault experienced by manufacturing equipment 124. An illustrative example for implementing fault detection module 115 is discussed with regards to FIG. 7.

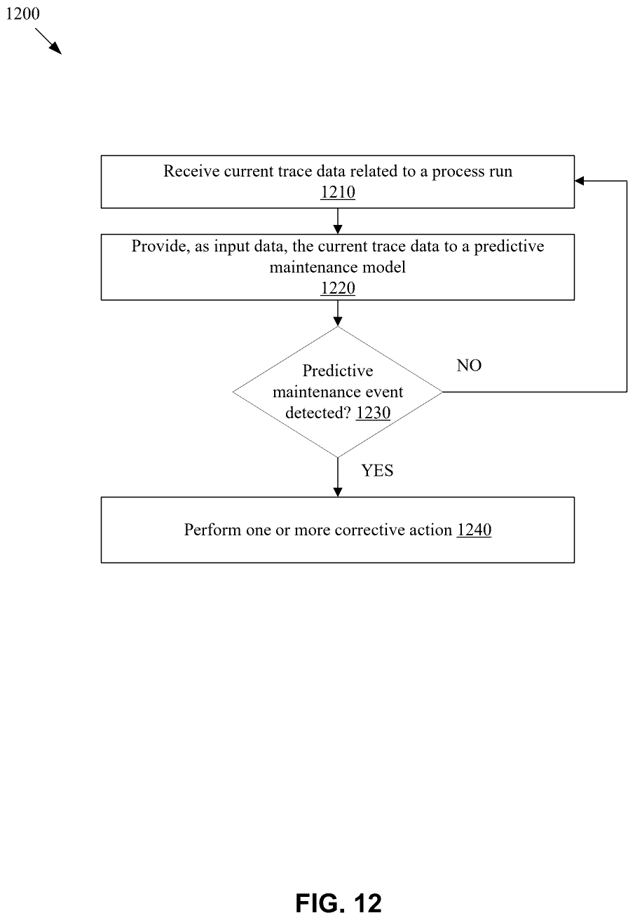

Predictive maintenance module 116 can detect whether a corrective maintenance event will occur within a certain number of process runs. In particular, predictive maintenance model can provide current trace data as input to predictive maintenance model 164 and receive, as output data, an indication of a likelihood of a corrective maintenance event occurring within a certain number of process runs. An illustrative example for implementing predictive maintenance module 116 is discussed with regards to FIG. 12.

Corrective action module 117 can receive user input (e.g., via GUI 152 displayed via the client device 150) of an indication associated with manufacturing equipment 124. In some implementations, the corrective action module 117 receives input data from fault detection module 115 and/or predictive maintenance model 164, determines a corrective action based on the input data, and causes the corrective action to be implemented. For example, responsive to receiving anomalous data (e.g., trace shapes, sensor spikes, drift data, etc.), correction action module 117 can perform one or more corrective action (e.g., increase power, decrease flowrate, etc.). In another example, responsive to receiving an indication sensor data (from the trace shape) satisfied a threshold criterion (e.g., exceeded or fell below a fault detection limit), the correction action module 117 can perform one or more corrective actions. The corrective actions can be stored in a library on data store 140. In some implementations, corrective action module 117 can receive an indication of a corrective action from the predictive system 160 (e.g., from predictive maintenance model 164) and cause the corrective action to be implemented.

Although shown as modules of server device 110, each module 111-117 can be included in one or more other computing devices, such as a rackmount server, a router computer, a server computer, a personal computer, a mainframe computer, a laptop computer, a tablet computer, a desktop computer, a GPU, an ASIC, etc. Each module 111-117 can execute instructions to perform any one or more of the methodologies and/or implementations described herein. The instructions can be stored on a computer readable storage medium, which can include the main memory, static memory, secondary storage and/or processing device (during execution of the instructions).

Data store 140 can be a memory (e.g., random access memory), a drive (e.g., a hard drive, a flash drive), a database system, or another type of component or device capable of storing data. Data store 140 can include multiple storage components (e.g., multiple drives or multiple databases) that can span multiple computing devices (e.g., multiple server computers). The data store 140 can store data associated with processing a substrate at manufacturing equipment 124. For example, data store 140 can store data collected by sensors 126 at manufacturing equipment 124 before, during, or after a substrate process (referred to as process data). Process data can refer to historical process data (e.g., process data generated for a prior substrate processed at the manufacturing system) and/or current process data (e.g., process data generated for a current substrate processed at the manufacturing system). Data store can also store spectral data or non-spectral data associated with a portion of a substrate processed at manufacturing equipment 124. Spectral data can include historical spectral data and/or current spectral data.

Data store 140 can also store contextual data associated with one or more substrates processed at the manufacturing system. Contextual data can include a recipe name, recipe step number, preventive maintenance indicator, operator, etc. Contextual data can refer to historical contextual data (e.g., contextual data associated with a prior process performed for a prior substrate) and/or current process data (e.g., contextual data associated with current process or a future process to be performed for a prior substrate). The contextual data can further include identify sensors that are associated with a particular sub-system of a process chamber.

Data store 140 can also store task data. Task data can include one or more sets of operations to be performed for the substrate during a deposition process and can include one or more settings associated with each operation. For example, task data for a deposition process can include a temperature setting for a process chamber, a pressure setting for a process chamber, a flow rate setting for a precursor for a material of a film deposited on a substrate, etc. In another example, task data can include controlling pressure at a defined pressure point for the flow value. Task data can refer to historical task data (e.g., task data associated with a prior process performed for a prior substrate) and/or current task data (e.g., task data associated with current process or a future process to be performed for a substrate).

In some implementations, data store 140 can store statistics data. Statistics data can include statistics representative of the raw data, generated by SSM 112, e.g., mean data (average), range data, standard deviation data, maximum and minimum data, median data, mode data, etc. Mean data can include a measured averages of two or more values. For example, mean data can be used to determine the average heater temperature, the process chamber pressure, the average flowrate of a gas, etc., during a step(s), a specific time duration, an entire process recipe, etc. Range data can include the middle observation in a set of data (e.g., a median temperature during a step). Range data can include the difference between a maximum value and a minimum value of a set of values (e.g. the range of the heater pressure during a process recipe). The standard deviation is measure of the amount of variation or dispersion of a set of values.

In some implementations, data store 140 can be configured to store data that is not accessible to a user of the manufacturing system. For example, process data, spectral data, contextual data, etc. obtained for a substrate being processed at the manufacturing system is not accessible to a user (e.g., an operator) of the manufacturing system. In some implementations, all data stored at data store 140 can be inaccessible by the user of the manufacturing system. In other or similar implementations, a portion of data stored at data store 140 can be inaccessible by the user while another portion of data stored at data store 140 can be accessible by the user. In some implementations, one or more portions of data stored at data store 140 can be encrypted using an encryption mechanism that is unknown to the user (e.g., data is encrypted using a private encryption key). In other or similar implementations, data store 140 can include multiple data stores where data that is inaccessible to the user is stored in one or more first data stores and data that is accessible to the user is stored in one or more second data stores.

The server device 110, client device 150, manufacturing equipment 124, sensors 126, predictive system 160, and data store 140 can be coupled to each other via a network 130. In some implementations, network 130 is a public network that provides server device 110 and client device 150 with access to predictive system 160, data store 140, manufacturing equipment 124 and other publicly available computing devices. In some implementations, network 130 is a private network that provides server device 110 and client device 150 access to manufacturing equipment 124, data store 140, predictive system 160, and other privately available computing devices. Network 130 can include one or more wide area networks (WANs), local area networks (LANs), wired networks (e.g., Ethernet network), wireless networks (e.g., an 802.11 network or a Wi-Fi network), cellular networks (e.g., a Long-Term Evolution (LTE) network), routers, hubs, switches, server computers, cloud computing networks, and/or a combination thereof.

In implementations, a “user” can be represented as a single individual. However, other implementations of the disclosure encompass a “user” being an entity controlled by a plurality of users and/or an automated source. For example, a set of individual users federated as a group of administrators can be considered a “user.”

FIG. 2 is a top schematic view of an example manufacturing system 200, according to aspects of the present disclosure. Manufacturing system 200 can perform one or more processes on a substrate 202. Substrate 202 can be any suitably rigid, fixed-dimension, planar article, such as, e.g., a silicon-containing disc or wafer, a patterned wafer, a glass plate, or the like, suitable for fabricating electronic devices or circuit components thereon.

Manufacturing system 200 can include a process tool 204 and a factory interface 206 coupled to process tool 204. Process tool 204 can include a housing 208 having a transfer chamber 210 therein. Transfer chamber 210 can include one or more process chambers (also referred to as processing chambers) 214, 216, 218 disposed therearound and coupled thereto. Process chambers 214, 216, 218 can be coupled to transfer chamber 210 through respective ports, such as slit valves or the like. Transfer chamber 210 can also include a transfer chamber robot 212 configured to transfer substrate 202 between process chambers 214, 216, 218, load lock 220, etc. Transfer chamber robot 212 can include one or multiple arms where each arm includes one or more end effectors at the end of each arm. The end effector can be configured to handle particular objects, such as wafers, sensor discs, sensor tools, etc.

Process chambers 214, 216, 218 can be adapted to carry out any number of processes on substrates 202. A same or different substrate process can take place in each processing chamber 214, 216, 218. A substrate process can include atomic layer deposition (ALD), physical vapor deposition (PVD), chemical vapor deposition (CVD), etching, annealing, curing, pre-cleaning, metal or metal oxide removal, or the like. Other processes can be carried out on substrates therein. Process chambers 214, 216, 218 can each include one or more sensors configured to capture data for substrate 202 before, after, or during a substrate process. For example, the one or more sensors can be configured to capture spectral data and/or non-spectral data for a portion of substrate 202 during a substrate process. In other or similar implementations, the one or more sensors can be configured to capture data associated with the environment within process chamber 214, 216, 218 before, after, or during the substrate process. For example, the one or more sensors can be configured to capture data associated with a temperature, a pressure, a gas concentration, etc. of the environment within process chamber 214, 216, 218 during the substrate process.

In some implementations, metrology equipment (not shown) can be located within the process tool. In other implementations, metrology equipment (not shown) can be located within one or more process chambers 214, 216, 218. In some implementations, the substrate can be placed onto metrology equipment using transfer chamber robot 212. In other implementations, the metrology equipment can be part of the substrate support assembly (not shown). Metrology equipment can provide metrology data associated with substrates processed by manufacturing equipment 124. The metrology data can include a value of film property data (e.g., wafer spatial film properties), dimensions (e.g., thickness, height, etc.), dielectric constant, dopant concentration, density, defects, etc. In some implementations, the metrology data can further include a value of one or more surface profile property data (e.g., an etch rate, an etch rate uniformity, a critical dimension of one or more features included on a surface of the substrate, a critical dimension uniformity across the surface of the substrate, an edge placement error, etc.). The metrology data can be of a finished or semi-finished product. The metrology data can be different for each substrate. Metrology data can be generated using, for example, reflectometry techniques, ellipsometry techniques, TEM techniques, and so forth.

A load lock 220 can also be coupled to housing 208 and transfer chamber 210. Load lock 220 can be configured to interface with, and be coupled to, transfer chamber 210 on one side and factory interface 206. Load lock 220 can have an environmentally-controlled atmosphere that can be changed from a vacuum environment (wherein substrates can be transferred to and from transfer chamber 210) to an at or near atmospheric-pressure inert-gas environment (wherein substrates can be transferred to and from factory interface 206) in some implementations. Factory interface 206 can be any suitable enclosure, such as, e.g., an Equipment Front End Module (EFEM). Factory interface 206 can be configured to receive substrates 202 from substrate carriers 222 (e.g., Front Opening Unified Pods (FOUPs)) docked at various load ports 224 of factory interface 206. A factory interface robot 226 (shown dotted) can be configured to transfer substrates 202 between carriers (also referred to as containers) 222 and load lock 220. Carriers 222 can be a substrate storage carrier or a replacement part storage carrier.

Manufacturing system 200 can also be connected to a client device (e.g., client device 110, not shown) that is configured to provide information regarding manufacturing system 200 to a user (e.g., an operator). In some implementations, the client device can provide information to a user of manufacturing system 200 via one or more graphical user interfaces (GUIs). For example, the client device can provide information regarding a target thickness profile for a film to be deposited on a surface of a substrate 202 during a deposition process performed at a process chamber 214, 216, 218 via a GUI. The client device can also provide information regarding trace matching and/or predictive maintenance in accordance with implementations described herein.

Manufacturing system 200 can also include a system controller 228. System controller 228 can be and/or include a computing device such as a personal computer, a server computer, a programmable logic controller (PLC), a microcontroller, and so on. System controller 228 can include one or more processing devices, which can be general-purpose processing devices such as a microprocessor, central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device can also be one or more special-purpose processing devices such as an application specific integrated circuit (ASIC), a field programmable gate array (FPGA), a digital signal processor (DSP), network processor, or the like. System controller 228 can include a data storage device (e.g., one or more disk drives and/or solid state drives), a main memory, a static memory, a network interface, and/or other components. System controller 228 can execute instructions to perform any one or more of the methodologies and/or implementations described herein. In some implementations, system controller 228 can execute instructions to perform one or more operations at manufacturing system 200 in accordance with a process recipe. The instructions can be stored on a computer readable storage medium, which can include the main memory, static memory, secondary storage and/or processing device (during execution of the instructions).

System controller 228 can receive data from sensors (e.g., sensors 126, now shown) included on or within various portions of manufacturing system 200 (e.g., processing chambers 214, 216, 218, transfer chamber 210, load lock 220, etc.). In some implementations, data received by the system controller 228 can include spectral data and/or non-spectral data for a portion of substrate 202. In other or similar implementations, data received by the system controller 228 can include data associated with processing substrate 202 at processing chamber 214, 216, 218, as described previously. For purposes of the present description, system controller 228 is described as receiving data from sensors included within process chambers 214, 216, 218. However, system controller 228 can receive data from any portion of manufacturing system 200 and can use data received from the portion in accordance with implementations described herein. In an illustrative example, system controller 228 can receive data from one or more sensors for process chamber 214, 216, 218 before, after, or during a substrate process at the process chamber 214, 216, 218. Data received from sensors of the various portions of manufacturing system 200 can be stored in a data store 250. Data store 250 can be included as a component within system controller 228 or can be a separate component from system controller 228. In some implementations, data store 250 can be data store 140 described with respect to FIG. 1.

FIG. 3 depicts an illustrative predictive architecture 300, according to aspects of the present disclosure. In some implementations, predictive architecture 300 include predictive system 160, network 130, and data store 310 (which can be similar to the same as data store 140). In some implementations, predictive system 160 can use a model (e.g., Guardband model 162, predictive maintenance model 164, etc.) to detect and/or identify anomalous data, identify an issue that can cause a corrective maintenance event, determine a corrective action, etc. In some implementations, predictive system 160 can use a model to detect an anomaly. Multiple models can be generated (e.g., trained) and configured for use by ADM 114 and/or fault detection model 115. In some implementations, each model 190 can be referred to as a “predictive subsystem”. In some implementations, predictive system 160 can include predictive server 112, server machines 170 and 180, and predictive server 195. The predictive server 160, server machine 170, server machine 180, and predictive server 195 can each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

Server machine 170 includes a training set generator 172 that is capable of generating training data sets (e.g., a set of data inputs and a set of target outputs) to train, validate, and/or test a machine-learning model 190. Machine-learning model 190 can be any algorithmic model capable of learning from data. In some implementations, machine-learning model 190 can be a predictive model. In some implementations, the data set generator 172 can partition the training data into a training set, a validating set, and a testing set, which can be stored, as part of the training statistics 312, in the training data store 310. Training statistics 312 which can be accessible to the computing device predictive system 160 directly or via network 130. In some implementations, the predictive system 160 generates multiple sets of training data.

Server machine 180 can include a training engine 182, a validation engine 184, a selection engine 185, and/or a testing engine 186. An engine can refer to hardware (e.g., circuitry, dedicated logic, programmable logic, microcode, processing device, etc.), software (such as instructions run on a processing device, a general-purpose computer system, or a dedicated machine), firmware, microcode, or a combination thereof. Training engine 182 can be capable of training one or more machine-learning model 190. Machine-learning model 190 can refer to the model artifact that is created by the training engine 182 using the training data (also referred to herein as a training set) that includes training inputs and corresponding target outputs (correct answers for respective training inputs). The training engine 182 can find patterns in the training data that map the training input to the target output (the answer to be predicted), and provide the machine-learning model 190 that captures these patterns. The machine-learning model 190 can use one or more of a statistical modelling, support vector machine (SVM), Radial Basis Function (RBF), clustering, supervised machine-learning, semi-supervised machine-learning, unsupervised machine-learning, k-nearest neighbor algorithm (k-NN), linear regression, random forest, neural network (e.g., artificial neural network), etc.

One type of machine-learning model that can be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities can be addressed, at lower layers, on top of which a multi-layer perceptron is commonly appended, mapping top layer features extracted by the convolutional layers to decisions (e.g., classification outputs). Deep learning is a class of machine-learning algorithms that use a cascade of multiple layers of nonlinear processing units for feature extraction and transformation. Each successive layer uses the output from the previous layer as input. Deep neural networks can learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In a plasma process tuning, for example, the raw input can be process result profiles (e.g., thickness profiles indicative of one or more thickness values across a surface of a substrate); the second layer can compose feature data associated with a status of one or more zones of controlled elements of a plasma process system (e.g., orientation of zones, plasma exposure duration, etc.); the third layer can include a starting recipe (e.g., a recipe used as a starting point for determining an updated process recipe the process a substrate to generate a process result the meets threshold criteria). Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs can be that of the network and can be the number of hidden layers plus one. For recurrent neural networks, in which a signal can propagate through a layer more than once, the CAP depth is potentially unlimited.

In one implementation, one or more machine-learning model is a recurrent neural network (RNN). An RNN is a type of neural network that includes a memory to enable the neural network to capture temporal dependencies. An RNN is able to learn input-output mappings that depend on both a current input and past inputs. The RNN will address past and future flow rate measurements and make predictions based on this continuous metrology information. RNNs can be trained using a training dataset to generate a fixed number of outputs (e.g., to determine a set of substrate processing rates, determine modification to a substrate process recipe). One type of RNN that can be used is a long short term memory (LSTM) neural network.

Training of a neural network can be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset.

A training dataset containing hundreds, thousands, tens of thousands, hundreds of thousands or more sensor data and/or process result data (e.g., metrology data such as one or more thickness profiles associated with the sensor data) can be used to form a training dataset.

To effectuate training, processing logic can input the training dataset(s) into one or more untrained machine-learning models. Prior to inputting a first input into a machine-learning model, the machine-learning model can be initialized. Processing logic trains the untrained machine-learning model(s) based on the training dataset(s) to generate one or more trained machine-learning models that perform various operations as set forth above. Training can be performed by inputting one or more of the sensor data into the machine-learning model one at a time.

The machine-learning model processes the input to generate an output. An artificial neural network includes an input layer that consists of values in a data point. The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer can be another hidden layer or an output layer. In either case, the nodes at the next layer receive the output values from the nodes at the previous layer, and each node applies weights to those values and then generates its own output value. This can be performed at each layer. A final layer is the output layer, where there is one node for each class, prediction and/or output that the machine-learning model can produce.

Accordingly, the output can include one or more predictions or inferences. In some implementations, an output prediction or inference can include one or more predictions relating to anomaly detection, trace shape classification, etc. In some implementations, an output prediction or inference can include one or more predictions of anomaly data, fault data, fault detection limits, trace shape classifiers, etc. Processing logic determines an error (i.e., a classification error) based on the differences between the output (e.g., predictions or inferences) of the machine-learning model and target labels associated with the input training data. Processing logic adjusts weights of one or more nodes in the machine-learning model based on the error. An error term or delta can be determined for each node in the artificial neural network. Based on this error, the artificial neural network adjusts one or more of its parameters for one or more of its nodes (the weights for one or more inputs of a node). Parameters can be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters can include adjusting the weights assigned to each of the inputs for one or more neurons at one or more layers in the artificial neural network.

After one or more rounds of training, processing logic can determine whether a stopping criterion has been met. A stopping criterion can be a target level of accuracy, a target number of processed images from the training dataset, a target amount of change to parameters over one or more previous data points, a combination thereof and/or other criteria. In one implementation, the stopping criteria is met when at least a minimum number of data points have been processed and at least a threshold accuracy is achieved. The threshold accuracy can be, for example, 70%, 80% or 90% accuracy. In one implementation, the stopping criterion is met if accuracy of the machine-learning model has stopped improving. If the stopping criterion has not been met, further training is performed. If the stopping criterion has been met, training can be complete. Once the machine-learning model is trained, a reserved portion of the training dataset can be used to test the model.

Once one or more trained machine-learning models 190 are generated, they can be stored in predictive server 195 as predictive component 197 or as a component of predictive component 197.

The validation engine 184 can be capable of validating machine-learning model 190 using a corresponding set of features of a validation set from training set generator 172. Once the model parameters have been optimized, model validation can be performed to determine whether the model has improved and to determine a current accuracy of the deep learning model. The validation engine 184 can determine an accuracy of machine-learning model 190 based on the corresponding sets of features of the validation set. The validation engine 184 can discard a trained machine-learning model 190 that has an accuracy that does not meet a threshold accuracy. In some implementations, the selection engine 185 can be capable of selecting a trained machine-learning model 190 that has an accuracy that meets a threshold accuracy. In some implementations, the selection engine 185 can be capable of selecting the trained machine-learning model 190 that has the highest accuracy of the trained machine-learning models 190.

The testing engine 186 can be capable of testing a trained machine-learning model 190 using a corresponding set of features of a testing set from data set generator 172. For example, a first trained machine-learning model 190 that was trained using a first set of features of the training set can be tested using the first set of features of the testing set. The testing engine 186 can determine a trained machine-learning model 190 that has the highest accuracy of all of the trained machine-learning models based on the testing sets.

As described in detail below, predictive server 195 includes a predictive component 197 that is capable of providing data indicative of corrective maintenance prediction data, and running trained machine-learning model 190 on data items such as sensor data, statistics data, etc. input to obtain one or more outputs. The predictive server 195 can further provide fault detection data, anomaly detection data, trace shape classification data. etc. This will be explained in further detail below.

It should be noted that in some other implementations, the functions of server machines 170 and 180, as well as predictive server 195, can be provided by a fewer number of machines. For example, in some implementations, server machines 170 and 180 can be integrated into a single machine, while in some other or similar implementations, server machines 170 and 180, as well as predictive server 195, can be integrated into a single machine.

In general, functions described in one implementation as being performed by server machine 170, server machine 180, and/or predictive server 195 can also be performed on client device 110. In addition, the functionality attributed to a particular component can be performed by different or multiple components operating together.

In some implementations, a manufacturing system can include more than one process chambers. For example, example manufacturing system 200 of FIG. 2 illustrates multiple process chambers 214, 216, 218. It should be noted that, in some implementations, data obtained to train the machine-learning model 190 and data collected to be provided as input to the machine-learning model can be associated with the same process chamber of the manufacturing system. In other or similar implementations, data obtained to train the machine-learning model and data collected to be provided as input to the machine-learning model can be associated with different process chambers of the manufacturing system. In other or similar implementations, data obtained to train the machine-learning model can be associated with a process chamber of a first manufacturing system and data collected to be provide as input to the machine-learning model can be associated with a process chamber of a second manufacturing system.

FIGS. 4A-D are flow diagrams of methods 400A-D associated with guardbands, in accordance with some implementations of the present disclosure. In some implementations, methods 400A-D are performed by processing logic that includes hardware (e.g., circuitry, dedicated logic, programmable logic, microcode, processing device, etc.), software (such as instructions run on a processing device, a general-purpose computer system, or a dedicated machine), firmware, microcode, or a combination thereof. In some implementations, methods 400A-D are performed, at least in part, by predictive system 160 and/or client device 110. In some implementations, a non-transitory storage medium stores instructions that when executed by a processing device (e.g., of predictive system 160, of server machine 180, of predictive server 1105, etc.) cause the processing device to perform one or more of methods 400A-D.

For simplicity of explanation, methods 400A-D are depicted and described as a series of operations. However, operations in accordance with this disclosure can occur in various orders and/or concurrently and with other operations not presented and described herein. Furthermore, in some implementations, not all illustrated operations are performed to implement methods 400A-D in accordance with the disclosed subject matter. In addition, those skilled in the art will understand and appreciate that methods 400A-D could alternatively be represented as a series of interrelated states via a state diagram or events.

In some implementations, FIGS. 4A-D are directed to sequential data guardband analysis for improved fault diagnostics, fault classification, and prediction (e.g., sequential guardband analysis for fault detection and classification (FDC)). In some implementations, the present disclosure provides improves analysis of a sequential data stream (e.g., trace data) using guardband fault diagnostics full trace analysis (FTA) to provide improved detection, classification, and prediction including reduced false alarms (e.g., false positives) and missed alarms (e.g., missed positives). The present disclosure may use guardbands to analyze both transient and steady-state regions and to extract complex features (e.g., more complex than unique variable analysis (UVA)).

A guardband of the present disclosure may be used to detect anomalies or faults that occur in trace data but may not conform to a typical anomaly shape such as a spike or oscillation. Guardbands of the present disclosure may be provided in isolation or may be combined with other analysis capabilities such as semi-automated feature extraction (SFE).

A guardband may be a channel defined for a data stream that is meant to identify a region of commonality (e.g., acceptable values) as a function of the position in the data stream. The data stream (e.g., trace data) is often the value of a sensor over the course of some event such as a production run. For example, the data stream can be a sequence of data values presented and positioned as a function of time (e.g., x-axis is time). The sequencing may not be time based (e.g., may be an indication of count of something such as number of products produced or number of errors logged). The term “acceptable” is a function of the application environment and objective of the guardband analysis. For example, “acceptable” could be “not-anomalous” or “not-faulty.” The guardband channel may have an upper and lower limit. In some implementations, these limits may be calculated using statistical methods along the duration of the data stream. For example, the channel could represent +/−3-sigma of the value of multiple traces of a particular sensor, where variance is calculated at each time value of the data stream. Smoothing techniques (e.g., time window averaging) may be employed to allow the channel to be more noise resistant and smooth.

FTA guardbanding may be used for anomaly trace with minor oscillation at transient segments. FTA guardbanding may be used to analyze multiple traces or trace partition from a particular sensor over multiple runs. FTA guardbanding may establish upper and lower limits that indicate a normal range or channel for the sensor data over time (e.g., 3-sigma). The solution identifies and profiles excursions from the guardband. FTA capability can be used along with SFE in a complementary fashion to provide for comprehensive analysis and as input to a fingerprint library. A guardband can be associated with a single sensor (UVA) or across multiple sensors (multivariate analysis (MVA)). For MVA, the sensor value (e.g., y-axis) may be a metric that represents some combination of the sensors involved in the MVA.

In some implementations, a guardband may include multiple guardbands (e.g., a warning guardband fully contained within an error guardband). In some implementations, a first area is a normal region regardless of other parameters, a second area is a region where classification of good or bad is based on analysis of other parameters, and a third area is a faulty region regardless of other parameters.

In some implementations, the x-axis parameter of the guardband or the parameter that defines sequencing aspect of the data is time (e.g., granularly associated with the sensor(s) read rate). In some implementations, a substrate number in a process tool may correspond to substrate processes.

In some implementations, the guardband violation definition may be an anomaly, fault, warning, event trigger, and/or prediction. Guardband violation determination and interpretation may relate to the purpose of the guardband (e.g., fault or anomaly detection). A single data point outside of the guardband channel may indicate a fault. A probability distribution function may be used to define the area, duration, and magnitudes of portions that includes violation areas in the trace. These violation areas may be evaluated (e.g., violation area attribute values) to interpret if there is a fault.

FIGS. 4A-4D are flow diagrams of methods 400A-D associated with generating a guardband, according to certain implementations. FIG. 4A is a flow diagram of a method 400A associated with generating a guardband, FIG. 4B is a flow diagram of a method 400B associated with using a guardband, FIG. 4C is a flow diagram of a method 400C associated with generating a guardband via machine-learning (e.g., via a model 190), and FIG. 4D is a flow diagram of a method 400D associated with using a guardband via machine-learning (e.g., via a model 190).

Referring to FIG. 4A, in some implementations, at operation 402, the processing logic identifies trace data associated with production, via a substrate processing system, of substrates (e.g., good substrates) that have property values that meet threshold values. Trace data includes a separate set of sensor data over time for each of the substrates. In some implementations, trace data includes sensor data (e.g., different types of sensor data) from multiple different sensors for each of the substrates.

At operation 404, the processing logic determines, based on the trace data, allowable types of variance (e.g., of a guardband).

In some implementations, processing logic generates a guardband based on the trace data. The guardband may include an upper limit and a lower limit for fault detection (e.g., anomaly detection). In some implementations, to form a guardband, an average of all of the trace data is generated and then offsets from the average (e.g., three sigma) is used as the upper limit and the lower limit. In some implementations, the upper limit and the lower limit are equally distanced from the average of the trace data. Since the trace data is for good substrates, any variations from the guardband formed by the trace data are allowable types of variance.

In some implementations, operation 404 includes processing logic determining trace-to-trace variability of the trace data at operation 410. In some implementations, the allowable types of variance include trace-to-trace variability of time shifts. The trace data may include sensor values (e.g., y-axis) over time (e.g., x-axis). Due to differing times of starting to record the sensor data, some of the sets of sensor data over time may be offset (e.g., time shift, in the x-axis). In some implementations, the processing logic tracks trace-to-trace differences and autonomously adjusts guardband variance horizontally when a normal time shifting variance is found. This prevents false positives when a recipe step or trace slightly shifts. This increases the robustness and reduces false positives.

In some implementations, operation 404 includes processing logic determining an upper limit different from a lower limit based on the trace data at operation 412. In some implementations, the allowable types of variance include a first allowable type of variance to form the upper limit of the guardband and a second allowable type of variance to form the lower limit of the guardband. The first allowable type (e.g., quantity) of variance may be different from the second allowable type (e.g., quantity) of variance. Variation on each side of the guardband is to be computed separately (e.g., during signal transitions) and reduces false positives.

In some implementations, operation 404 includes processing logic determining position-dependent variance of the trace data at operation 414. Parameters and weighting (e.g., duration, level, area, concatenation of successive violations, etc.) and other guardband settings can be adjusted as a function of the position (e.g., along x-axis) in the guardband. Examples include: 1) adjusting along the x-axis corresponding to different operations along a process so the guardband is more/less sensitive or adaptive; 2) adjusting guardband as a function of the characteristics of the signal (e.g., less aggressive in an area where guardband is changing rapidly in the y-direction and more aggressive in an area where the guardband value is relatively constant); 3) adjusting guardband as a function of alarms detected along the guardband (e.g., adjusting the distribution parameters after a first spike is detected to be more or less sensitive to future spike features on that trace); etc. This improves guardband performance and further allows subject matter expertise incorporation into guardband analysis.

In some implementations, operation 404 includes processing logic determining trace segmentation of the trace data at operation 416. In some implementations, the allowable types of variance are further based on segmentation of portions of the trace data (e.g., associated with change in values that exceeds a threshold change, values within the threshold). For example, a feature (e.g., within a threshold) may trigger a wider guardband for a next segment of the guardband. In some implementations, the allowable types of variance are further based on extraction of features from the trace data.

In some implementations, operation 404 includes processing logic performing feature extraction (e.g., semi-auto feature extraction (SFE)) of the trace data at operation 418. For example, the guardband parameters may be changed for different segments or for different features. This improves guardband performance and overall analysis by allowing the combining of different capabilities (e.g., guardband, feature extraction, and/or trace segmentation).

In some implementations, the trace data includes sensor data from different types of sensors and the allowable types of variance is via MVA. MVA metric combining values of multiple sensors into a single metric (e.g., first principal component in principal component analysis (PCA)). Guardband parameters may be applied across multiple guardbands using MVA techniques. Examples include: 1) determining violations and violation distributions as function of violation characteristics across two or more traces occurring (or not occurring) simultaneously; and/or 2) dynamics associated with a guardband for a signal based on that signal for one or more other signals. This improves guardband performance, further allows subject matter expertise incorporation into guardband analysis, and allows addressing of correlation across multiple signals.

In some implementations, the features include one or more of: persistent features (e.g., ramps and flats); user defined features (e.g., concatenation of ramps and slopes); intermittent features, such as ramps, flats, and FTA features; x-offset; y-offset; shape; length; warping; etc.

At operation 405, the processing logic generates, based on the allowable types of variance, a guardband. For example, the guardband may allow for time shifts (e.g., in the x-axis), upper limit and lower limit that are different, multi-variable (e.g., multi-variate) analysis, segmentation of portions of the trace data, extraction of features of the trace data, etc. In some implementations, the guardband is generated by training a machine-learning model, as shown in FIG. 4C.

At operation 408, the processing logic causes, based on the guardband, performance of a corrective action associated with the substrate processing system. Operation 408 may include comparing additional trace data to the guardband to determine whether to perform the corrective action (e.g., see FIG. 4B).

Referring to FIG. 4B, in some implementations, at operation 422, the processing logic identifies trace data associated with substrate production via a substrate processing system (e.g., the same substrate processing system as FIG. 4A). The trace data may be associated with substrates that is unknown whether the property data of the substrates meets threshold values (e.g., good substrates) or do not meet threshold values (e.g., bad substrates). Trace data includes a separate set of sensor data over time for each of the substrates. In some implementations, trace data includes sensor data (e.g., different types of sensor data) from multiple different sensors for each of the substrates.

At operation 424, the processing logic compares the trace data to a guardband that has been generated based on allowable types of variance (e.g., see operation 406 of FIG. 4A). The guardband may have an upper limit and a lower limit for data points over time.

At operation 426, the processing logic determines one or more data points of the trace data are not within the guardband. The one or more data points may include at least one data point above the upper limit and/or at least one data point below the lower limit (e.g., the data points do not match data points of substrates that have property values that meet threshold values).

At operation 428, processing logic causes performance of a corrective action associated with the substrate processing system. In some implementations, the corrective action includes providing an alert, interrupting substrate processing equipment, causing inspection of the substrate, discarding the substrate, updating manufacturing parameters, etc. In some implementations, the performance of the corrective action is specific to the type or quantity of data points that are outside of the guardband.

Referring to FIG. 4C, in some implementations, at operation 442, the processing logic identifies historical trace data associated with production, via a substrate processing system, of substrates. In some implementations, the substrates (e.g., good substrates) have property values that meet threshold values. Operation 442 may be similar to operation 402 of FIG. 4A. In some implementations, the substrates (e.g., bad substrates) have property values that do not meet threshold values.

In some implementations, at operation 444, the processing logic identifies historical performance data associated with the historical trace data. In some examples, the historical performance data is indicates whether the substrates are good substrates or are bad substrates (e.g., all the substrates have property values that meet threshold values, all of the substrates have property values that do not meet threshold values).

At operation 446, the processing logic trains a machine-learning model with data input including the historical trace data (e.g., and target output including the historical performance data) to generate a trained machine-learning model indicative of a guardband associated with allowable types of variance. The training of the machine-learning model may cause the guardband to be based on the allowable types of variance described in operation 404 of FIG. 4A.

The trained machine-learning model may be used to determine whether additional trace data meets the guardband (e.g., see FIG. 4D).

Referring to FIG. 4D, in some implementations, at operation 462, the processing logic identifies trace data associated with substrate production via a substrate processing system (e.g., the same substrate processing system as FIG. 4C). The trace data may be associated with substrates that is unknown whether the property data of the substrates meets threshold values (e.g., good substrates) or do not meet threshold values (e.g., bad substrates). Operation 462 may be similar to operation 442 of FIG. 4B.

At operation 464, the processing logic provides the trace data as input to a trained machine-learning model (e.g., trained machine-learning model of operation 446 of FIG. 4C) associated with a guardband generated based on allowable types of variance.

At operation 466, the processing logic receives from the trained machine-learning model, output indicative of predictive data.

At operation 468, the processing logic determines, based on the predictive data, that one or more data points of the trace data are not within the guardband of the trained machine-learning model. The one or more data points may be above the upper limit of the guardband or may be below the lower limit of the guardband.

At operation 470, the processing logic causes, based on the predictive data, performance of a corrective action associated with the substrate processing system. Operation 470 may be similar to operation 428 of FIG. 4B.

FIG. 5 illustrates an example guardband violation profiling, in accordance with some implementations of the present disclosure. Graph 500 illustrates trace data for production of a substrate. Graph 500 also illustrates a guardband that include an upper limit 506 and a lower limit 504. Reference data 502 (e.g., baseline data obtained from training sets) can be used to generate the threshold values. Trace data 508 can include data obtained from a process run, and sets of data points that fall outside of the guardband limits can be referred to as sets of guardband violation data points 510A, 510B (e.g., sets of data points associated with guardband violation). These sets of guardband violation data points 510A, 510B that can be indicative of a bad substrate, or indicative of a false positives. Violation segment 512 indicates the section where the violation data points occurred

FIG. 6 is a diagram of the framework for performing maintenance event diagnostics and predictive maintenance, according to some aspects of the present disclosure. Diagnostic dashboard 610 can include a GUI to display data related to one or more process chambers of manufacturing equipment 124. In some implementations, diagnostic dashboard can be similar or the same as dashboard 154 of FIG. 1. In some implementations, diagnostic dashboard 610 can generate a heat map configured to track the output data generated by the sensors or by one or more sensor groups. In some implementations, the heat map can show fault indicative data, status data, and so forth for one or more sensors, one or more process chambers, one or more components of a process chamber or manufacturing equipment 124, etc. For example, the fault indicative data can indicate whether the data output from one or more the particular sensors is within normal range, at or near a fault limit, or exceed the fault limit, and so forth. In some implementations, if a predetermined amount of the particular sensors satisfies a threshold criterion (e.g., are at or exceed a fault limit), the fault indicative data can visually represent this by changing color or shade.

ADM 630 can process sensor data and trace data by performing one or more event matching operations. In some implementations, ADM 630 can be ADM 114 of FIG. 1. In some implementations, diagnostic module 630 can perform one or more event matching operations. An event matching operation can include, for example, comparing sensor and/or trace data (e.g., data over time) from one or more process runs (or portions of a process run), one or more maintenance events, and/or from reference data.

In some implementations, at the start of each process run (e.g., at the tool-up event after a maintenance is performed), a guardband can be applied to the process run. The guardband can monitor for trace data exceeding an upper and/or lower limit. For example, during a particular portion of the process run, the process chamber temperature can be expected to be maintained at value “x”, where guardband upper limit can be twenty percent above “x” and the guardband lower limit can be twenty percent below “x.” In response to an excursion (e.g., the trace data exceeding the upper or lower level), the data related to the excursion can be flagged, labeled, and/or stored. For example, one or more trace matching operations can be performed, comparison data can be generated, a list of sensor related to the excursion can be generated, etc.

In some implementations, ADM 630 can perform one or more of quality recipe trace matching, fingerprint recipe trace matching, diagnostic matching, pre-corrective maintenance matching, post maintenance matching, pre-post maintenance matching. The quality recipe trace matching can compare reference trace data from one or more sensors (and/or data related to the trace data, such as, for example, guardband data applied to each process run) to the current trace data (e.g., trace data and/or trace related from one or more process runs prior to the initiation of the maintenance event). In some implementations, ADM 630 can determine whether the difference is reference trace data and current trace satisfies a threshold criterion. The threshold criterion can include the difference in sensor values at corresponding steps satisfying a threshold value, the number of instances when the difference in sensor values at corresponding steps satisfying a threshold value, a duration of a current sensor value exceeding a limit set in relation to the reference trace data satisfying a threshold value, etc.

The fingerprint recipe trace matching can compare a reference fingerprint(s) from one or more sensors (and/or data related to the trace data, such as, for example, guardband data) to a current fingerprint (e.g., a fingerprint from one or more process runs prior to the initiation of the maintenance event). A fingerprint can refer to a profile generated for the trace data by assigning a set of labels or values to certain points and/or sensor during one or more process runs. For example, the profile can reflect the sum of the values at each second of a process run, a matrix or array of values at certain intervals, etc. ADM 630 can then determine whether the difference between the reference fingerprint and the current fingerprint satisfies a threshold criterion (e.g., whether the different between values satisfied a threshold value).

The diagnostic matching can compare trace data and/or trace related data obtained from a process run to trace data and/or trace related data obtained from one or more process runs prior to a tool-down event occurring (a fault that requires shutting down a process chamber or the manufacturing equipment to perform a corrective maintenance). For example, trace data can be selected from the process runs approximately the mid-way between a tool-up event and the corrective maintenance event.

The pre-corrective maintenance matching can compare trace data and/or trace related data obtained from one or more process runs prior to the start of two respective maintenance events. For example, trace data can be selected from right prior to a prior maintenance event (e.g., preventive maintenance event or corrective maintenance event) and trace data can be selected from right prior to a current corrective maintenance event.

The post maintenance diagnostic operation can compare trace data and/or trace related data obtained from one or more process runs after two respective maintenance events. For example, trace data can be selected from the start of two process run after completion of respective maintenance events. In an illustrative example, ADM 630 compare, using summary statistics, a first sensor group and a second sensor group. The first sensor group can include data from process runs after a maintenance event and the second sensor group can include data from process runs after a prior maintenance event or reference data. The comparison data can be recorded in database 650. In some implementations, in response to the summary statistics being significantly different (e.g., satisfying a threshold criterion such as a threshold difference value), ADM 630 can provide the comparison data to fault detection module 620.

The pre-post maintenance diagnostic operation trace data and/or trace related data obtained from process runs prior to performing a maintenance event to trace data and/or trace related data obtained from process runs right after completing the maintenance event.

Fault detection module 620 can perform a set of diagnostic operations to determine the root cause of an corrective maintenance (e.g., due to a tool-down event). In some implementations, fault detection module can be fault detection module 115 of FIG. 1.

FIG. 7. is a flow chart of a method 700 for performing the set of diagnostic operations to determine the root cause of a corrective maintenance operation, according to aspects of the present disclosure. Method 700 is performed by processing logic that can include hardware (circuitry, dedicated logic, etc.), software (such as is run on a general-purpose computer system or a dedicated machine), firmware, or some combination thereof. In one implementation, method 700 can be performed by a computer system, such as computer system architecture 100 of FIG. 1. In other or similar implementations, one or more operations of method 700 can be performed by one or more other machines not depicted in the figures. In some aspects, one or more operations of method 700 can be performed by server device 150.

For simplicity of explanation, the methods are depicted and described as a series of acts. However, acts in accordance with this disclosure can occur in various orders and/or concurrently, and with other acts not presented and described herein. Furthermore, not all illustrated acts can be performed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 710, processing logic performs an event matching operation using summary statistics. The processing logic can compare the summary statistics of two groups of sensor data. In particular, the processing logic compares sensor data between one or more process runs prior to a corrective maintenance event (referred to as the “bad” process runs) and sensor data from one or more “good” process runs performed after the last tool-up event. A good process runs can refer to an instance where the substrate is fabricated exactly or close to desired specifications. Summary statistics can refer to sensor data summarized across a particular recipe or recipe operation associated with the production of a substrate. This summarization is defined using a set of statistics such as mean and variance. The comparison data can be stored in, for example, a database, such as data store 140.

At operation 720, processing logic determines whether the comparison reflects statistically significant differences. For example, the processing logic can determine whether the difference in the data satisfy a threshold criterion. In some implementations, the summary statistics are compared to set limits such as a mean value being between a lower and upper value. If the sensor data is within the limits, it is estimated that the substrate will meet particular property values and if the sensor data is outside of the limits, it is estimated that the substrate will not meet particular property values. Responsive to the determining that the comparison reflects statistically significant differences, the processing logic proceeds to operation 725 where the processing logic identifies the sensor(s) related to the fault. These sensors can be labeled are the root cause of the corrective maintenance. In some implementations, this data can be used to train model 190 (e.g., predictive maintenance model 164, 640), which can then be used to determine sensor data obtained from a future process run is indicative of a possible corrective maintenance event occurring. Responsive to the determining that the comparison does not reflect statistically significant differences, the processing logic proceeds to operation 730.

At operation 730, processing logic normalizes the sensor data of the process runs. In particular, processing logic can obtain the guardband data from the one or more process runs prior to a corrective maintenance event and sensor data from one or more “good” process runs performed after the last tool-up event. The processing logic then normalizes the data so that it can be compared. In particular, to normalize the data, the processing logic can transform the output values (e.g., trace data) of a dataset into a normalized dataset such that the normalized dataset retains certain features (e.g., sensor spikes) from the original dataset while constrained in a set of predefined limits.

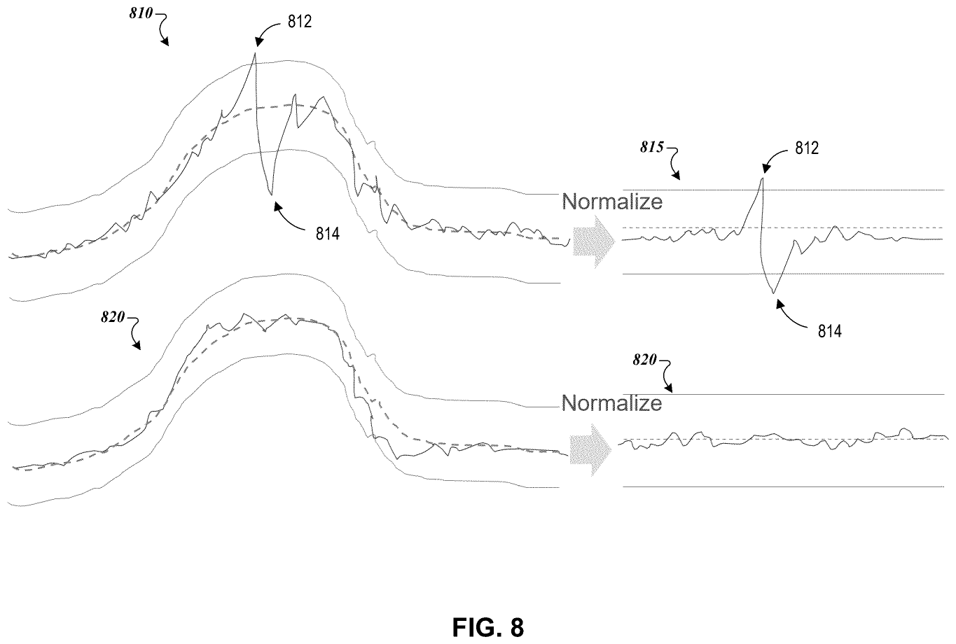

FIG. 8 is a diagram illustrating normalizing guardband data, according to aspects of the present disclosure. As shown, graph 810 can reflect sensor data from a process runs prior to a corrective maintenance event and graph 820 can reflect sensor data from a “good” process run. Both sets of trace data follow a curved path between an upper and lower guardband limit. The trace data of graph 810 has two excursion incidents 812 and 814 where the trace data went outside the limits of the guardbands. Graph 815 and 820 show the normalized trace data of graphs 810 and 820 respectively.

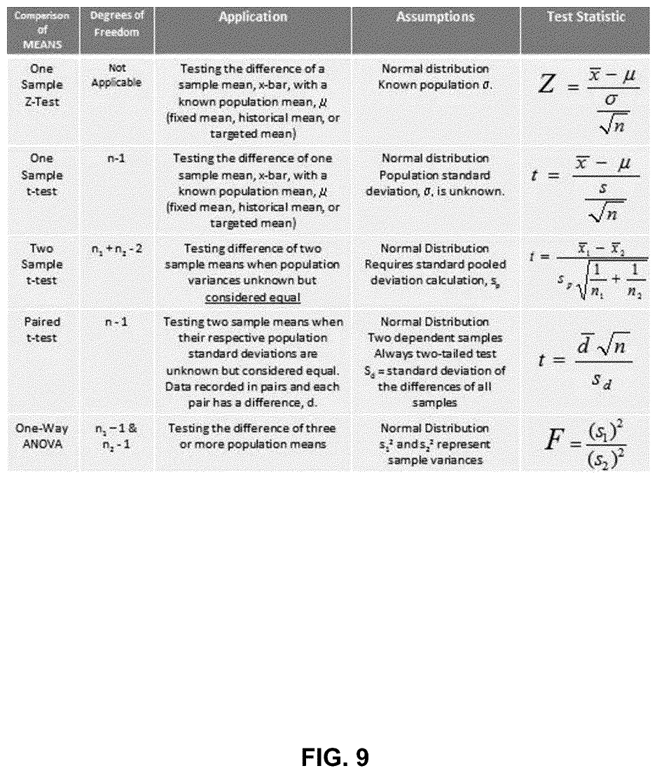

Returning to FIG. 7, at operation 740, processing logic compares the normalized trace data from the two groups using trace matching. In some implementations, the processing logic can perform one or more statistical tests on the normalized trace data. The statistical tests can include, for example, a one sample Z-test (to test mean difference between the sensor groups), a one sample t-test. A two-sample t-test, a paired t-test, a one-way ANOVA test, an F-test (to test variation difference between two sensor groups), etc. The Z-tests can test the mean difference between the trace data. FIG. 9 is a diagram illustrating a listing of tests in the first column, corresponding degrees of freedom in the second column, the application of the tests in the third column, assumption made in the fourth column, and respective formulas in the fifth column.

At operation 750, processing logic determines whether the trace matching data reflects statistically significant differences. In particular, the processing logic can determine whether the difference in the trace matching data satisfies a threshold criterion, whether the trace matching failed one or more statistical tests, etc. For example, the processing logic can determine whether a mean value obtained from a statistical test is between a lower and upper value. Responsive to the processing logic determining that the trace matching reflects statistically significant differences (e.g., the mean value is outside the lower or upper value), the processing logic proceeds to operation 725 and identifies the sensor(s) related to the fault. In some implementations, this data can be used by corrective action model 116 to determine a corrective action. In some implementations, this data can be used to train model 190. Responsive to the determining that the trace matching does not reflect statistically significant differences (e.g., the mean value is outside the lower or upper value), the processing logic proceeds to operation 760.

At operation 760, the processing logic performs a new event matching operation using summary statistics. In some implementations, the processing logic can compare the summary statistics of the groups of sensor data related to the bad process run and the group of sensors related to the process runs prior to a preventive maintenance event. The processing logic can then proceed to operation 720 to determine whether the comparison reflects statistically significant differences. Method 700 can loop based on the new event matching operation to obtain additional data to determine the root cause of a corrective maintenance operation and/or obtain training data for predictive maintenance model 164.

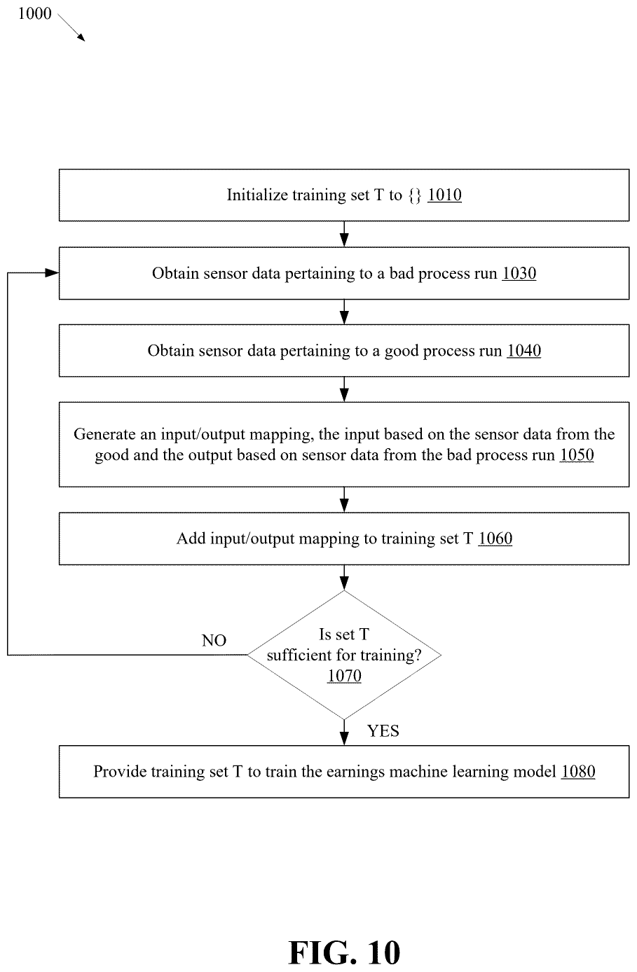

FIG. 10 depicts a flow diagram of an example method 1000 for training predictive maintenance model to generate predictive data reflecting a possible upcoming corrective maintenance event, in accordance with implementations of the present disclosure. Method 1000 can be performed by processing logic that can include hardware (circuitry, dedicated logic, etc.), software (e.g., instructions run on a processing device), or a combination thereof. In one implementation, some or all of the operations of method 1000 can be performed by one or more components of predictive system 160 of FIG. 1.

At operation 1010, processing logic initiates training set T to { } (e.g., to empty).

At operation 1030, processing logic obtains sensor data pertaining to a bad process run that occurred prior to a corrective maintenance event. In some implementations, the sensor data can include trace data, data generated by method 700 of FIG. 7, and so forth.

At operation 1040, processing logic obtains sensor data pertaining to a good process run that occurred prior to a corrective maintenance event. In some implementations, the sensor data (or trace data) from the good process run can include reference data, data from a process run performed after a previous maintenance event, data from a process run performed prior to the bad process run, etc.

At operation 1050, processing logic generates an input/output mapping, the input based on the sensor data from the good process run and the output based on the sensor data from the bad process run.

At operation 1060, processing logic adds the input/output mapping to training set T.

At operation 1070, processing logic determines whether set T is sufficient for training. In response to processing logic determining that set T is not sufficient for training, method 1000 can return to operation 1030. The processing logic can then select another one or more images of a person without makeup and the corresponding one or more images of the person with makeup. In response to processing logic determining that set T is sufficient for training, method 1000 can proceed to operation 1080.

At operation 1080, processing logic provides training set T to train a predictive maintenance model, such as predictive maintenance model 164, 640, as described above

Once the processing logic provides the training set T to train the predictive maintenance model, the predictive maintenance model can be trained to generate, for current sensor and/or trace data, predictive data related to whether a corrective maintenance event will occur. In an example, the predictive maintenance model can receive, as input, current trace data from a process run and provide, as output, an indication that a corrective maintenance may occur in a certain number of process runs, which sensors may be at fault to trigger the corrective maintenance event, etc. For example,

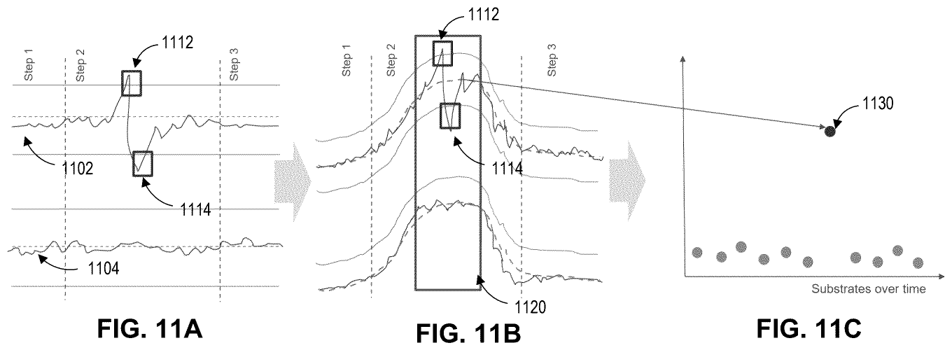

FIGS. 11A-11C are graphs illustrating example data used to train the predictive maintenance model, according to aspects of the present disclosure. FIG. 11A shows normalized trace data from a bad process run 1102 and from a good process run 1104. In the bad process run, there are two excursions 1112, 1114 that reflect anomalies in the trace data. FIG. 11B shows a window 1120 isolating the anomalies within the same region of the good process run and the bad process run of the guardband trace data. FIG. 11C shows the calculating statistics of key sensors from the trace window 1120 which can be used, via the predictive maintenance model, to detect the same issue in future process runs.

FIG. 12 is a flow chart of a method 1200 for generating predictive data indicative of whether a corrective maintenance event may occur, according to aspects of the present disclosure. Method 1200 is performed by processing logic that can include hardware (circuitry, dedicated logic, etc.), software (such as is run on a general-purpose computer system or a dedicated machine), firmware, or some combination thereof. In one implementation, method 1200 can be performed by a computer system, such as computer system architecture 100 of FIG. 1. In other or similar implementations, one or more operations of method 1200 can be performed by one or more other machines not depicted in the figures. In some aspects, one or more operations of method 1200 can be performed by client device 150, server device 110, predictive maintenance module 116, 660, and/or predictive server 195.

At operation 1210, processing logic receives current trace data related to a process run. The current trace data can be associated with a manufacturing operation.

At operation 1220, processing logic provides, as input data, the current trace data to a predictive maintenance model, such as, for example, predictive maintenance model 164, 640. In some implementations, the predictive maintenance model can be generated (and/or trained) using method 1000 discussed in FIG. 10.

At operation 1230, processing logic determines whether the predictive maintenance model detected a predictive maintenance event in the current trace data. For example, the processing logic can generate output data indicative a likelihood of a corrective maintenance event occurring within a certain number of process runs. Responsive to the processing logic failing to detect a predictive maintenance event, the processing logic proceeds to operation 1210 to receive subsequent current trace data. Responsive to the processing logic detecting a predictive maintenance event, the processing logic proceeds to operation 1240.

At operation 1240, processing logic provides performs one or more corrective action. For example, the processing logic can alert the user and advice the user of various corrective options, such as changing parameters of the manufacturing process, pausing the manufacturing process (e.g., for a quick maintenance), stopping the manufacturing process (e.g., for more extensive repairs), or the like. In some implementations, the processing device can take multiple remediation actions, e.g., adjust settings of the manufacturing process, schedule maintenance, and alert the user.

Returning to FIG. 6, data generated by ADM 630, fault detection module 620, and predictive maintenance model 640 can be stored on database 650. This data can be used by predictive maintenance module 660 to determine a likelihood of a corrective maintenance event occurring within a certain number of process runs, as discussed above in method 1200. Health index 680 can be used to display a GUI reflecting data related to the output of predictive maintenance model 640. For example, the health index 680 can display an alert, a remaining number of process runs remaining until the maintenance event is predicted to occur, a recommend corrective action, etc.

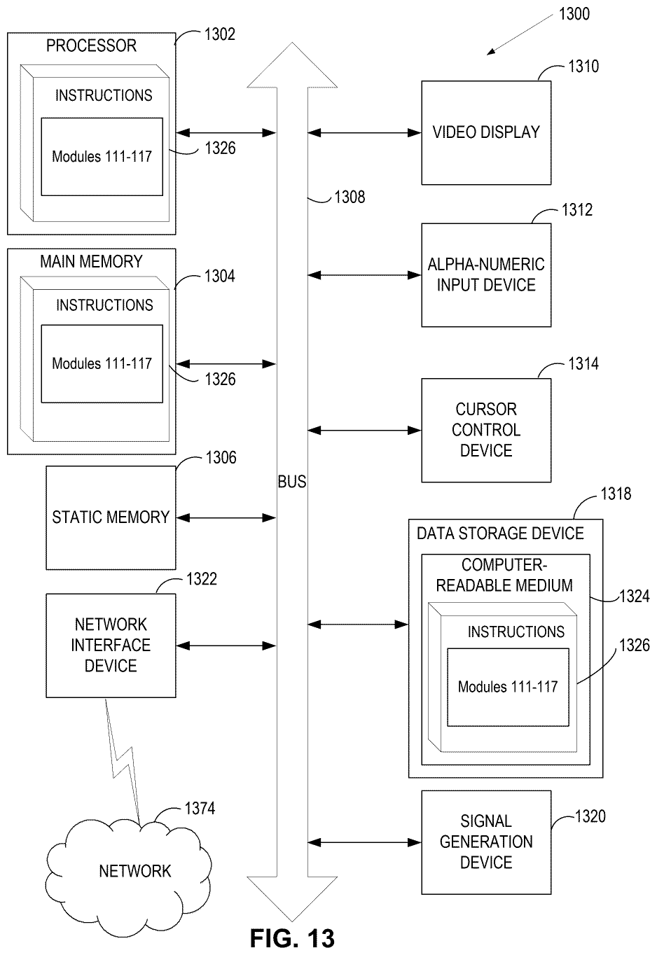

FIG. 13 is a block diagram illustrating a computer system 1300, according to certain implementations. In some implementations, computer system 1300 can be connected (e.g., via a network, such as a Local Area Network (LAN), an intranet, an extranet, or the Internet) to other computer systems. Computer system 1300 can operate in the capacity of a server or a client computer in a client-server environment, or as a peer computer in a peer-to-peer or distributed network environment. Computer system 1300 can be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 1300 can include a processing device 1302, a volatile memory 1304 (e.g., Random Access Memory (RAM)), a non-volatile memory 1306 (e.g., Read-Only Memory (ROM) or Electrically-Erasable Programmable ROM (EEPROM)), and a data storage device 1316, which can communicate with each other via a bus 1308.

Processing device 1302 can be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 1300 can further include a network interface device 1322 (e.g., coupled to network 1374). Computer system 1300 also can include a video display unit 1310 (e.g., an LCD), an alphanumeric input device 1312 (e.g., a keyboard), a cursor control device 1314 (e.g., a mouse), and a signal generation device 1320.

In some implementations, data storage device 1316 can include a non-transitory computer-readable storage medium 1324 on which can store instructions 1326 encoding any one or more of the methods or functions described herein, including instructions encoding components of FIG. 1 (e.g., modules 111-117, etc.) and for implementing methods described herein.

Instructions 1326 can also reside, completely or partially, within volatile memory 1304 and/or within processing device 1302 during execution thereof by computer system 1300, hence, volatile memory 1304 and processing device 1302 can also constitute machine-readable storage media.

While computer-readable storage medium 1324 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as ASICS, FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can include a general purpose computer system selectively programmed by a computer program stored in the computer system. Such a computer program can be stored in a computer-readable tangible storage medium.

The methods and illustrative examples described herein are not inherently related to any particular computer or other apparatus. Various general purpose systems can be used in accordance with the teachings described herein, or it can prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A method, comprising:
responsive to an occurrence of a corrective maintenance event, obtaining first sensor data pertaining to a first process run and second sensor data pertaining to a second process run, wherein the first process run is associated with an occurrence of a fault that triggered the corrective maintenance event;
responsive to determining that a comparison of the first sensor data and the second sensor data fails to satisfy a first threshold criterion, generating a first normalized dataset based on the first sensor data and a second normalized dataset based on the second sensor data;
generating trace matching data by performing a trace matching operation on the first normalized dataset and the second normalized dataset; and
responsive to determining that the trace matching data satisfies a second threshold criterion, identifying a set of sensors associated with the first sensor data as the cause of the fault that triggered the corrective maintenance event.

2. The method of claim 1, further comprising:
training a machine-learning mode, using the trace matching data, to receive current sensor data as input and provide, as output, an indication of whether a corrective maintenance is expected to occur within a certain number of subsequent process runs.

3. The method of claim 1, further comprising:
responsive to determining that the trace matching data fails to satisfy the second threshold criterion, performing a comparison of the first sensor data and third sensor data pertaining to a third process run.

4. The method of claim 1, further comprising:
determining a root cause of the fault; and
performing at least one of generating an alert or performing a corrective action.

5. The method of claim 1, wherein generating the first normalized dataset comprises constraining trace data associated with the first sensor data within a set of predefined limits while retaining one or more data features.

6. The method of claim 1, wherein failing to satisfy the first threshold criterion comprises determining that a mean value associated with the comparison of the first sensor data and the second sensor data exceeds one or more limits.

7. The method of claim 1, wherein the second process run is associated with a preventive maintenance event.

8. A system, comprising:
a memory device; and
a processing device, operatively coupled to the memory device, to perform operations comprising:
responsive to an occurrence of a corrective maintenance event, obtaining first sensor data pertaining to a first process run and second sensor data pertaining to a second process run, wherein the first process run is associated with an occurrence of a fault that triggered the corrective maintenance event;
responsive to determining that a comparison of the first sensor data and the second sensor data fails to satisfy a first threshold criterion, generating a first normalized dataset based on the first sensor data and a second normalized dataset based on the second sensor data;
generating trace matching data by performing a trace matching operation on the first normalized dataset and the second normalized dataset; and
responsive to determining that the trace matching data satisfies a second threshold criterion, identifying a set of sensors associated with the first sensor data as the cause of the fault that triggered the corrective maintenance event.

9. The system of claim 8, wherein the operations further comprise:
training a machine-learning mode, using the trace matching data, to receive current sensor data as input and provide, as output, an indication of whether a corrective maintenance is expected to occur within a certain number of subsequent process runs.

10. The system of claim 8, wherein the operations further comprise:
responsive to determining that the trace matching data fails to satisfy the second threshold criterion, performing a comparison of the first sensor data and third sensor data pertaining to a third process run.

11. The system of claim 8, wherein the operations further comprise:
determining a root cause of the fault; and
performing at least one of generating an alert or performing a corrective action.

12. The system of claim 8, wherein generating the first normalized dataset comprises constraining trace data associated with the first sensor data within a set of predefined limits while retaining one or more data features.

13. The system of claim 8, wherein failing to satisfy the first threshold criterion comprises determining that a mean value associated with the comparison of the first sensor data and the second sensor data exceeds one or more limits.

14. The system of claim 8, wherein the second process run is associated with a preventive maintenance event.

15. A non-transitory computer-readable storage medium comprising instructions that, when executed by a processing device operatively coupled to a memory, performs operations comprising:
responsive to an occurrence of a corrective maintenance event, obtaining first sensor data pertaining to a first process run and second sensor data pertaining to a second process run, wherein the first process run is associated with an occurrence of a fault that triggered the corrective maintenance event;
responsive to determining that a comparison of the first sensor data and the second sensor data fails to satisfy a first threshold criterion, generating a first normalized dataset based on the first sensor data and a second normalized dataset based on the second sensor data;
generating trace matching data by performing a trace matching operation on the first normalized dataset and the second normalized dataset; and
responsive to determining that the trace matching data satisfies a second threshold criterion, identifying a set of sensors associated with the first sensor data as the cause of the fault that triggered the corrective maintenance event.

16. The non-transitory computer-readable storage medium of claim 15, wherein the operations further comprise:
training a machine-learning mode, using the trace matching data, to receive current sensor data as input and provide, as output, an indication of whether a corrective maintenance is expected to occur within a certain number of subsequent process runs.

17. The non-transitory computer-readable storage medium of claim 15, wherein the operations further comprise:
responsive to determining that the trace matching data fails to satisfy the second threshold criterion, performing a comparison of the first sensor data and third sensor data from a third process run.

18. The non-transitory computer-readable storage medium of claim 15, wherein the operations further comprise:
determining a root cause of the fault; and
performing at least one of generating an alert or performing a corrective action.

19. The non-transitory computer-readable storage medium of claim 15, wherein generating the first normalized dataset comprises constraining trace data associated with the first sensor data within a set of predefined limits while retaining one or more data features.

20. The non-transitory computer-readable storage medium of claim 15, wherein failing to satisfy the first threshold criterion comprises determining that a mean value associated with the comparison of the first sensor data and the second sensor data exceeds one or more limits.
